(19) United States
(12) Patent Application Publication
(10) Pub. No.: US 2016/0323082 A1
(43) Pub. Date: Nov. 3, 2016

(54) COMMUNICATION DEVICE AND MANAGING METHOD

(71) Applicant: FUJITSU LIMITED, Kawasaki-shi (JP)

(72) Inventor: Naotoshi WATANABE, Yokohama (JP)

(73) Assignee: FUJITSU LIMITED, Kawasaki-shi (JP)

(21) Appl. No.: 15/082,256

(22) Filed: Mar. 28, 2016

(30) Foreign Application Priority Data
May 1, 2015 (JP) 2015-094104

(51) Int. Cl. H04L 5/00; H04L 29/06

(52) U.S. Cl. CPC H04L 5/0053; H04L 63/0428

(57) ABSTRACT

A communication device includes: a processor configured to execute a process including: extracting, when an execution request of processing is received, a fixed identifier that is an identifier indicating a transmission source, and that has a fixed value, from the execution request; calculating a hash value of the fixed identifier extracted at the extracting, by using a predetermined hash function; creating a value that indicates the transmission source, and that includes the hash value calculated at the calculating in a part thereof, as an interim identifier that varies in value according to an execution condition of the processing; and communicating with the transmission source by using the interim identifier created at the creating.

### CROSS-REFERENCE TO RELATED APPLICATION

This application is based upon and claims the benefit of priority of the prior Japanese Patent Application No. 2015-094104, filed on May 1, 2015, the entire contents of which are incorporated herein by reference.

### FIELD

The embodiments discussed herein are related to a communication device and a managing method.

### BACKGROUND

In recent years, a technique of network function virtualization has been known in which a network function implemented by a dedicated hardware is virtualized by executing a network function application on a general purpose server. As one example of such a network function application, an application that implements a function of a serving/packet data network gateway (S/P-GW), a mobility management entity (MME), and the like is considered.

Moreover, by applying a network function application to a cloud system, it is expected to achieve resource allocation according to demand changes or flexible response to troubles. As a subject to which such a network function application is applied, a scale-out cluster system in which packets are divided among multiple information processing servers according to a fixed identifier indicating a client (hereinafter, described as fixed identifier) such as a user identifier is considered.

For example, a cluster system has multiple information processing servers and an allocation server that performs allocation of packets. Furthermore, when receiving a packet from a client, the allocation server extracts a fixed identifier from the received packet, and calculates a hash value of the extracted fixed identifier. The allocation server then transfers the packet to an information processing server according to the calculated hash value. As a result, the cluster system transfers packets to a unique server per client, thereby achieving provision of a continuous service (Japanese Patent No. 5544522, Japanese Laid-open Patent Publication Nos. 2014-67317 and 2013-182575).

However, in the cluster system described above, because packets are allocated to information processing servers according to a hash value of a fixed identifier, there is a problem that execution of the network function application in which an identifier indicating a client changes according to a processing condition is difficult.

For example, in third generation partnership project (3GPP), to prevent a fixed identifier from being stolen, there is a case in which an interim identifier that is valid only while a signaling session lasts is used. For example, when receiving a packet including a fixed identifier, the information processing server creates an interim identifier that indicates the client of a source of the packet, and informs the created interim identifier to the client. The information processing server and the client performs transmission and reception of packets using the interim identifier that has been created by the information processing server.

However, when such an interim identifier is used, a hash value is calculated based on the interim identifier, and therefore, packets included in an identical session are not necessarily transferred to the same information processing server. Accordingly, in the cluster system described above, it is difficult to guarantee the uniqueness of an information processing server to be a transfer destination of packets, thereby being difficult to provide a continuous service.

### SUMMARY

According to an aspect of the embodiments, a communication device includes: a processor configured to execute a process including: extracting, when an execution request of processing is received, a fixed identifier that is an identifier indicating a transmission source, and that has a fixed value, from the execution request; calculating a hash value of the fixed identifier extracted at the extracting, by using a predetermined hash function; creating a value that indicates the transmission source, and that includes the hash value calculated at the calculating in a part thereof, as an interim identifier that varies in value according to an execution condition of the processing; and communicating with the transmission source by using the interim identifier created at the creating.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram depicting one example of a communication system according to a first embodiment;

FIG. 2 is a block diagram depicting one example of an internal configuration of an MME;

FIG. 3 is a block diagram depicting one example of a functional configuration of an allocation server;

FIG. 4 is a diagram for explaining one example of information that is stored in a hash-value allocation table;

FIG. 5 is a diagram for explaining one example of information that is stored in an allocation-destination managing table;

FIG. 6 is a diagram for explaining one example of information that is stored in an embedded-value managing table;

FIG. 7 is a diagram for explaining one example of information that is stored in a rule specifying table;

FIG. 8 is a diagram for explaining one example of information that is stored in a rule table;

FIG. 9 is a block diagram depicting one example of a functional configuration of a data server;

FIG. 10 is a diagram for explaining one example of information that is stored in an unused tunnel identification (TID) list;

FIG. 11 is a sequence diagram indicating one example of processing performed by the allocation server and the data server;

FIG. 12 is a flowchart indicating one example of a flow of processing performed by the allocation server;

FIG. 13 is a flowchart indicating one example of a flow of processing performed by the data server;

FIG. 14 is a block diagram depicting one example of a functional configuration of a data server according to a second embodiment;

FIG. 15 is a sequence diagram indicating one example of processing performed by an allocation server and the data server according to the second embodiment;

FIG. 16 is a flowchart indicating one example of a flow of processing performed by the allocation server according to the second embodiment;

FIG. 17 is a flowchart indicating one example of a flow of processing performed by the data server according to the second embodiment;

FIG. 18 is a block diagram depicting one example of a functional configuration of an allocation server according to a third embodiment;

FIG. 19 depicts one example of information that is stored in a hash function table according to the third embodiment;

FIG. 20 is a block diagram depicting one example of a functional configuration of a data server according to the third embodiment;

FIG. 21 depicts one example of information that is stored in a data server list according to the third embodiment;

FIG. 22 is a sequence diagram indicating one example of processing performed by the allocation server and the data server according to the third embodiment;

FIG. 23 is a flowchart indicating one example of a flow of processing performed by the allocation server according to the third embodiment;

FIG. 24 is a flowchart indicating one example of a flow of processing performed by the data server according to the third embodiment;

FIG. 25 is a block diagram depicting one example of an internal configuration of an evolved Node B (eNB) and a S/P-GW;

FIG. 26 is a block diagram depicting a hardware configuration example of the allocation server and the data server;

FIG. 27 is a sequence diagram indicating a first example of processing performed by a related allocation server and data server; and

FIG. 28 is a sequence diagram indicating a second example of processing performed by the related allocation server and data server.

### DESCRIPTION OF EMBODIMENTS

Preferred embodiments will be explained with reference to accompanying drawings. In the embodiments, an identical reference symbol is assigned to components having an identical function, and duplicated explanation is omitted. Note that the embodiments below only indicate one example, and embodiments of the communication device and the managing method disclosed in the present application are not limited thereto. Moreover, the respective embodiments below may be appropriately combined within a range not causing contradiction.

### [a] First Embodiment

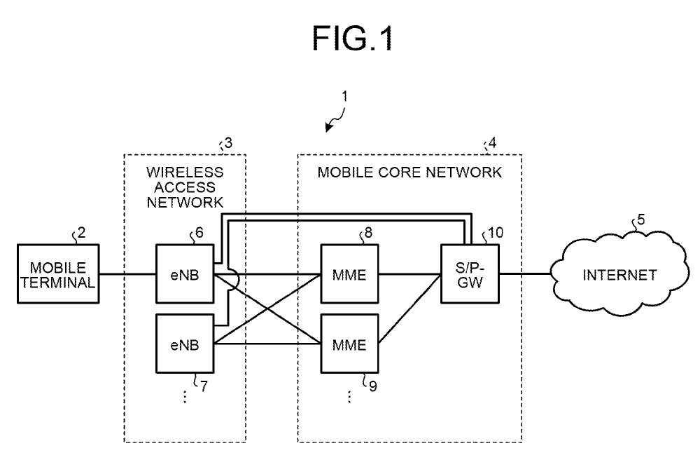

FIG. 1 is an explanatory diagram depicting one example of a communication system according to a first embodiment. As depicted in FIG. 1, a communication system 1 includes a mobile terminal 2, a wireless access network 3, a mobile core network 4, and an Internet 5. Furthermore, the wireless access network 3 includes an eNB 6 and an eNB 7. Moreover, the mobile core network 4 includes an MME 8, an MME 9, and an S/P-GW 10.

Note that the communication system 1 can accommodate an arbitrary number of the mobile terminals 2. Furthermore, the wireless access network 3 further includes multiple eNBs in addition. Furthermore, the mobile core network 4 further includes multiple MMEs in addition. Moreover, although a network configuration example of long term evolution (LTE) is depicted as one example of the communication system in the example depicted in FIG. 1, the disclosed technique is not limited thereto, but other arbitrary network configurations are also applicable.

For example, the mobile terminal 2 is a terminal device such as a smartphone, a feature phone, and a tablet terminal used by a user, and is a user equipment (UE) in LTE. The mobile terminal 2 transmits a packet or a transaction message in which a processing execution request is included to the mobile core network 4 through either one of the eNBs 6 and 7 included in the wireless access network 3, to receive provision of various kinds of services that are provided by the MME in the mobile core network 4. In the following explanation, a packet and a transaction message transmitted from the mobile terminal 2 are simply described as a message in some cases. Furthermore, although in the following explanation, an example in which the mobile terminal 2 is connected to the eNB 6 to perform communication is explained, embodiments are not limited thereto. For example, the mobile terminal 2 may change a counterpart to be connected from eNB 6 to eNB 7 as a result of changing the location.

The eNB 6 is a base station device that performs wireless communication based on LTE with the mobile terminal 2. For example, the eNB 6 executes an application (hereinafter, described as network app) that implements a function of a mobile communication network, and when receiving a message from the mobile terminal 2, transfers the message to the MME 8, the MME 9, and the like included in the mobile core network 4 by using a predetermined communication protocol. Moreover, when receiving a message about provision of various kinds of services from the MME 8, the MME 9, and the like, the eNB 6 transmits the received message to the mobile terminal 2. The eNBs 6 and 7 are connected to the S/P-GW 10 such that communication is possible, and may set a signal line used for communication between the mobile terminal 2 and the Internet 5 in a superimposed manner by applying a predetermined signal procedure to the eNBs 6 and 7 and the S/P-GW 10. Furthermore, the eNB 6 is connected to each of the MMEs included in the mobile core network 4 such that communication is possible. The eNB 7 is supposed to have the same function as that of the eNB 6, and explanation thereof is omitted. Moreover, in the following explanation, the eNB 6 is supposed to executed a network app A.

The MME 8 provides various kinds of services to the mobile terminal 2. For example, the MME 8 executes a network function application, and when receiving a message from the mobile terminal 2, performs various kinds of processing for the received message, and outputs a result of performing the processing to the mobile terminal 2. Furthermore, there is a case in which the MME 8 accesses the Internet 5 through the S/P-GW 10, and performs processing in coordination with a server on the Internet 5. The MME 9 is supposed to have the same function as that of the MME 8, and explanation thereof is omitted.

The S/P-GW 10 is a gateway device that relays between a communication protocol of the mobile core network 4 and a communication protocol of the Internet 5, and is, for example, a serving gateway (S-GW) of LTE and a packet gateway (P-GW). In the following explanation, the S/P-GW 10 is supposed to execute a network app to implement communication between the Internet 5 and the mobile core network 4.

The MME 8 has multiple data servers, and divides received data among the data servers according to a transmission source of a message such as a user that uses the mobile terminal of a transmission source, and an application being a transmission source of the message. The MME 8 then causes the data servers to perform processing, thereby exerting the function of the MME. That is, the MME 8 is implemented by applying a network function application that exerts the function of the MME of LTE to a scale-out cluster system.

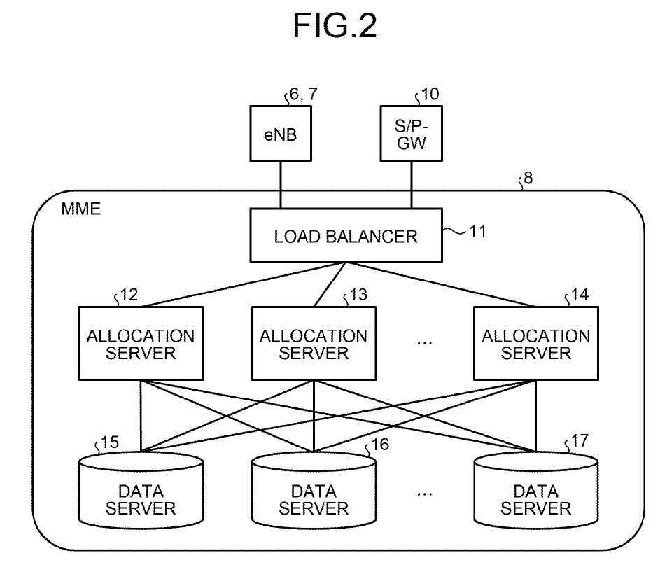

One example of the MME 8 according to the first embodiment is explained below. FIG. 2 is a block diagram depicting one example of an internal configuration of the MME. As depicted in FIG. 2, the MME 8 includes a load balancer 11, allocation servers 12 to 14, and data servers 15 to 17. The internal configuration of the MME 8 depicted in FIG. 2 is only an example, and the MME 8 may include an arbitrary number of allocation servers and data servers. Moreover, in the following explanation, the allocation servers 13 and 14 are supposed to have the same function as that of the allocation server 12, and explanation thereof is omitted. Furthermore, the data servers 16 and 17 are supposed to have the same function as that of the data server 15, and explanation thereof is omitted.

The load balancer 11 is an interface server that includes one or more representative addresses to an external system such as the mobile terminal 2 and the Internet 5. Moreover, when receiving a message, the load balancer 11 allocates the message to either of the allocation servers 12 to 14 according to a fixed rule, thereby distributing a processing load among the respective allocation servers 12 to 14. As for the rule in allocating a message by the load balancer 11, an arbitrary rule is applicable, such as allocating in round robin and allocating to an allocation server having low load.

When receiving a message, the allocation server 12 allocates the received message to either one of the data servers 15 to 17 according to a transmission source of the message. More specifically, the allocation server 12 allocates a message such that an allocation destination is uniquely decided from among the data servers 15 to 17 for a transmission source of the message. As a result, the load balancer 11 and the allocation server 12 can allocate a message even without holding condition information relating to a communication session, and therefore, it is possible to prevent occurrence of a bottleneck in scalability.

The data server 15 is a server that provides various kinds of services based on a received message. For example, when receiving a message from the allocation servers 12 to 14, the data server 15 identifies a transmission source of the received message, and performs various kinds of processing for the identified transmission source.

As described above, to the data server 15 to 17 included in the MME 8, a message is allocated by the load balancer 11 and the allocation servers 12 to 14. Therefore, the MME 8 can use resources without waste while ensuring reliability and redundancy, compared to active-standby (ACT-SBY) having a standby system that does not perform services. Moreover, the MME 8 can achieve allocation of a message by renewing an internet protocol (IP) address or by changing a route, without allocating the message to a standby system but by only changing a common rule of the allocation server 12, and therefore, it is possible to improve the operability.

In a related cluster system, a hash value of a fixed identifier having a fixed value, such as a user identifier that identifies a user being a transmission source of a message, is calculated, and the message is allocated to a data server according to the calculated hash value. As a result, in the related cluster system, a message is allocated to a unique data server per transmission source in a communication protocol, such as a session initiation protocol (SIP), in which a fixed identifier is used, and therefore, it has been able to provide various kinds of services to a user continuously. However, in a communication protocol, such as 3GPP, in which an interim identifier that is valid only while a signaling session lasts is used, a value of an identifier indicating a transmission source changes. Therefore, it is difficult for the related cluster system to allocate a message that is communicated by a communication protocol such as 3GPP to a unique data server per transmission source.

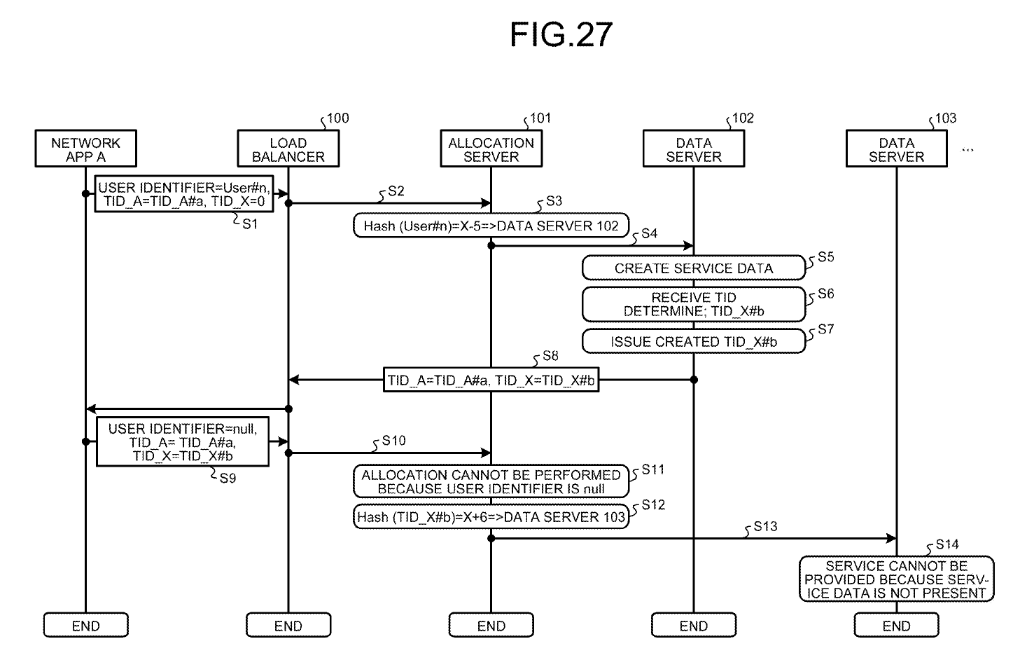

For example, FIG. 27 is a sequence diagram indicating a first example of processing performed by a related allocation server and data server. In the example in FIG. 27, one example of processing of allocating a message from the network app A executed by the eNB 6 performed by the related cluster system that includes a load balancer 100, an allocation server 101, and data servers 102 and 103 is indicated.

In the example in FIG. 27, the allocation server 101 calculates a hash value of a user identifier, which is a fixed identifier, by using a predetermined hash function. The allocation server 101 then allocates a message to the data server 102 when the calculated value is within a range of “0 to X”, and allocates a message to the data server 103 when the calculated value is within a range of “X+1 to Y”.

For example, the network app A transmits a message including a user identifier “User#n”, a TID_A “TID_A#a”, and a TID_X “0” to the load balancer 100 (step S1). The TID_A is an identifier to identify a transmission source of a message, and is an interim identifier issued by the network app A. Moreover, the TID_X is an identifier to identify a destination of the message, and is an interim identifier issued by the data servers 102 or 103 that receives the message.

The load balancer 100 transfers the message received from the network app A to the allocation server 101 in accordance with a predetermined rule (step S2). Moreover, when receiving a message, the allocation server 101 calculates a value of a hash value “Hash(User#n)” of the user identifier “User#n” (step S3). In the example indicated in FIG. 27, the allocation server 101 acquires a value “X−5” as the hash value “Hash(User#n)” by calculate, and therefore transmits the received message to the data server 102 (step S4).

When receiving the message, the data server 102 performs processing to provide a service, thereby creating service data to send back to the network app A (step S5). Moreover, the data server 102 creates “TID_X#b” as a TID_X for reception (step S6). The data server 102 then outputs created “TID_X#b” to the network app A (step S7). More specifically, the data server 102 transmits “TID_A#a” received from the network app A and created “TID_X#b” to the network app A along with the service data created at step S5 (step S8).

Furthermore, when transmitting a message to cause execution of more processing, the network app A transmits the message without including the user identifier in the message so as to prevent the user identifier from being stolen. Specifically, the network app A transmits “TID_A#a” and “TID_X#b” received at step S8 to the load balancer 100 together with the message (step S9). In such a case, the load balancer 100 transfers the received message to the allocation server 101 (step S10).

Because the user identifier is not included in the message transmitted at step S9, it is difficult for the allocation server 101 to perform allocation using the user identifier (step S11). Therefore, the allocation server 101 calculates a hash value “Hash(TID_X#b)” of the value of TID_X, for example. However, the value of TID_X is a different value from the user identifier, and therefore, in the example indicated in FIG. 27, the allocation server 101 acquires a value “X+6” as the hash value “Hash(TID_X#b)” by calculation (step S12).

As a result, the allocation server 101 transmits the received message to the data server 103 (step S13). However, because the data server 103 has not performed processing for the message previously transmitted by the network app A and has not stored the service data, it is difficult to provide continuous service even if the message is received (step S14).

Therefore, the MME 8 according to the first embodiment performs following management processing. First, when receiving a message from the network app A, the data server 15 extracts a user identifier, which is a fixed identifier, from the received message. The data server 15 then calculates a hash value of the extracted user identifier by using a predetermined hash function. The hash function used by the data server 15 is a hash function having the same hash space as the hash function that is used by the allocation server 12 when performing allocation.

Moreover, the data server 15 creates a value that is an identifier indicating a transmission source of the message, and that includes the hash value of the user identifier in a part thereof, as a value of TID_X output by the data server 15. For example, when a bit length of TID_X is n+m bits and is longer than a bit length of the hash value calculated from the user identifier, the data server 15 uses lower m bits out of the calculated hash value as lower m bits of TID_X. Furthermore, the data server 15 creates a value of TID_X in which a random number is stored in upper n bits of TID_X, as an interim identifier. The data server 15 then transmits the created interim identifier to the network app A, which is the transmission source of the message, to perform communication using the created interim identifier.

When the processing described above is performed, in TID_X informed to the network app A by the data server 15, a part of the hash value of the fixed identifier is to be stored. As a result, even if the fixed identifier is not included in a message that is received successively from the network app A, the allocation server 12 can extract a part of the hash value of the fixed identifier from the interim identifier included in the message. By performing allocation of the message according to the hash value extracted from the interim identifier included in the received message, the allocation server 12 can guarantee the uniqueness of a data server to be an allocation destination of the message.

The data server 15 may create an interim identifier that includes an entire hash value calculated from a fixed identifier. That is, the data server 15 is only requested to include a value that enables the allocation server 12 to maintain an allocation destination of a message uniquely out of the calculated hash value, in the interim identifier.

Other than the management processing described above, for example, by causing an allocation server to perform a function of converting from an interim identifier to a specific unique user identifier, a method in which a communication protocol using interim identifiers is applied in a scale-out cluster system can be considered. However, because a different value is assigned to a value of an interim identifier for each signaling session, each allocation server is requested to hold information indicating a processing state, thereby causing a bottleneck. Furthermore, although a method of issuing the same interim identifier per a counterpart system can be considered, it is difficult to make a format of an interim format conform to a communication protocol because a communication protocol to be used can differ for each interface. Moreover, also a method of synchronizing service data in all data servers can be considered. However, in this method, the use efficiency of resources is deteriorated with synchronization, and the operability is reduced.

On the other hand, the MME 8 according to the first embodiment can allocate a message to a data server according to a transmission source of the message as long as an interim identifier is included in the message, by performing the management processing described above. As a result, the MME 8 can realize application of a network app using an interim identifier a value of which changes according to processing to a scale-out cluster system, while preventing occurrence of a bottleneck, deterioration of the use efficiency of resources, and reduction in the operability.

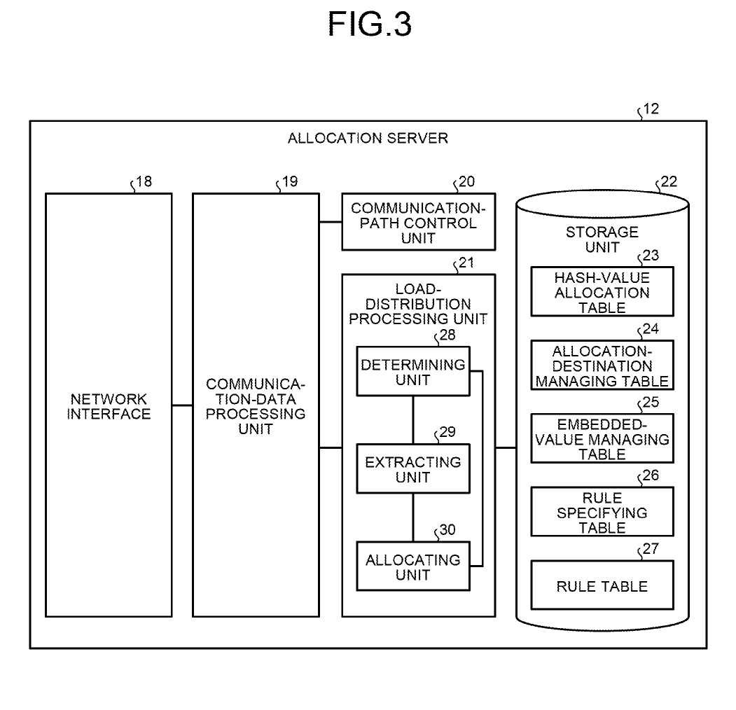

Function configurations of the allocation server 12 and the data server 15 that implements the management processing described above are explained below using the drawings. FIG. 3 is a block diagram depicting one example of a functional configuration of the allocation server. In the example depicted in FIG. 3, the allocation server 12 includes a network interface 18, a communication-data processing unit 19, a communication-path control unit 20, a load-distribution processing unit 21, and a storage unit 22. Moreover, the storage unit 22 includes a hash-value allocation table 23, an allocation-destination managing table 24, an embedded-value managing table 25, a rule specifying table 26, and a rule table 27. Furthermore, the load-distribution processing unit 21 includes a determining unit 28, an extracting unit 29, and an allocating unit 30.

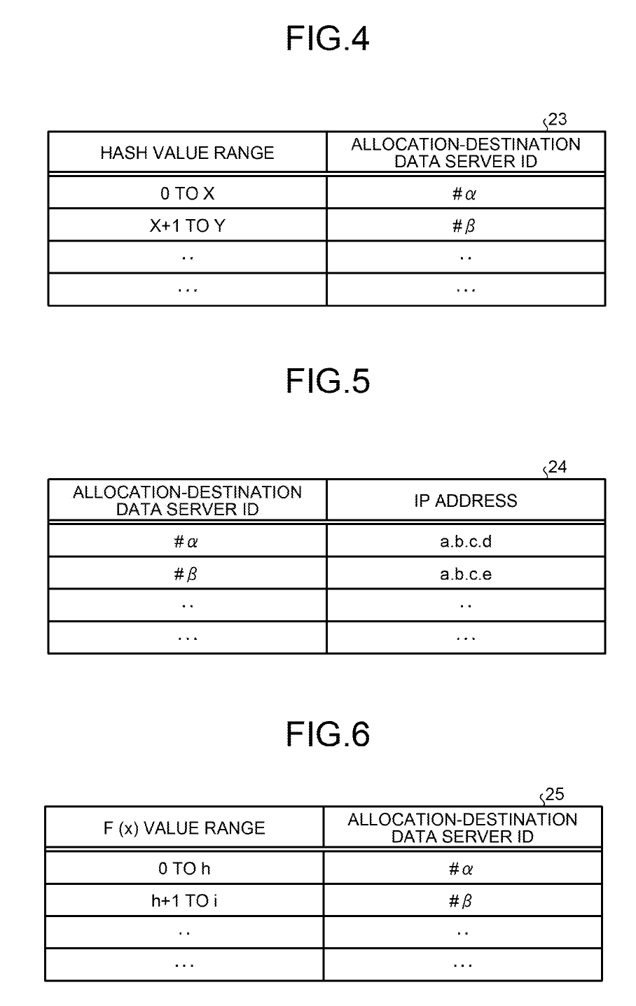

First, the respective tables 23 to 27 stored in the storage unit 22 are explained. In the hash-value allocation table 23, a hash value that is calculated from a fixed identifier and an allocation-destination data server of a message are registered in an associated manner. FIG. 4 is a diagram for explaining one example of information that is stored in the hash-value allocation table. In the hash-value allocation table 23, for example, as indicated in FIG. 4, a hash value range and an allocation-destination data server ID are registered in an associated manner. The hash value range is information that indicates a range of a hash value that is calculated from a fixed identifier. Furthermore, the allocation-destination data server ID is information that indicates a data server to be a transfer destination of a message.

For example, in the example indicated in FIG. 4, in the hash-value allocation table 23, an entry in which a hash value range “0 to X” and an allocation-destination data server ID “#α” are associated is included. The entry indicates that when a hash value calculated from a fixed identifier is included in the hash value range “0 to X”, the message is allocated to a data server (for example, the data server 15) indicated by the allocation-destination data server ID “#α”.

Moreover, in the example indicated in FIG. 4, in the hash-value allocation table 23, an entry in which a hash value range “X+1 to Y” and an allocation-destination data server ID “#β” are associated is included. The entry indicates that when a hash value calculated from a fixed identifier or a hash value included in an interim identifier is included in the hash value range “X+1 to Y”, the message is allocated to a data server indicated by the allocation-destination data server ID “#β”.

In the allocation-destination managing table 24, an address to transmit a message to the data servers 15 to 17 to be an allocation destination of a message is stored. FIG. 5 is a diagram for explaining one example of information that is stored in the allocation-destination managing table 24. In the allocation-destination managing table 24, for example, as indicated in FIG. 5, an allocation-destination data server ID and an IP address of a data server indicated by the allocation-destination data server ID are registered in an associated manner.

For example, in the example indicated in FIG. 5, in the allocation-destination managing table 24, the allocation-destination data server ID “#α” and an IP address “a.b.c.d” of the data server indicated by the allocation-destination data server ID “#α” are registered in an associated manner. Furthermore, in the example indicated in FIG. 5, in the allocation-destination managing table 24, the allocation-destination data server ID “#β” and an IP address “a.b.c.e” of the data server indicated by the allocation-destination data server ID “#β” are registered.

In the embedded-value managing table 25, a value of F(x) being a value of lower m bits out of a hash value calculated from a fixed identifier by the data servers 15 to 17 and an allocation destination of a message to which an interim identifier including the value F(x) are registered in an associated manner. FIG. 6 is a diagram for explaining one example of information that is stored in the an embedded-value managing table. In the embedded-value managing table 25, for example, as indicated in FIG. 6, an F(x) value range that is a range of a value of F(x) and an allocation-destination data server ID of a data server to be an allocation destination of a message to which an interim identifier in which F(x) is embedded is assigned are registered in an associated manner. In the example indicated in FIG. 6, in the embedded-value managing table 25, an F(x) value range “0 to h” and the allocation-destination data server ID “#α” are registered in an associated manner, and an F(x) value range “h+1 to I” and the allocation-destination data server ID “#β” are registered in an associated manner.

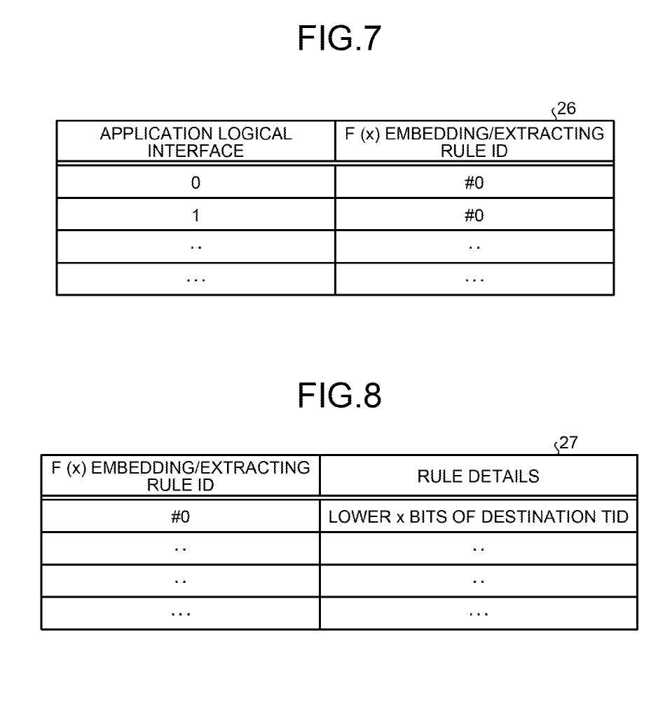

In the rule specifying table 26, an F(x) embedding/extracting rule that is a rule indicating where in an interim identifier F(x) is embedded is stored. For example, FIG. 7 is a diagram for explaining one example of information that is stored in the rule specifying table. In the example indicated in FIG. 7, in the rule specifying table 26, an application logical interface and an F(x) embedding/extracting rule ID that identifies a rule indicating where in an interim identifier F(x) is embedded are registered in an associated manner.

The application logical interface is a number of a logical interface that is used when the data server 15 performs processing for a message. For example, in the example indicated in FIG. 7, the rule specifying table 26 indicates that a rule indicated by an F(x) embedding/extracting rule ID “#0” is used when the application logical interface to be used when performing processing for a message is “0” or “1”.

In the rule table 27, details of a rule that indicates where in an interim identifier F(x) is embedded are stored. For example, FIG. 8 is a diagram for explaining one example of information that is stored in the rule table. In the example indicated in FIG. 8, in the rule table 27, an F(x) embedding/extracting rule ID and details of a rule indicated by the ID are stored in an associated manner. For example, in the rule table 27 indicated in FIG. 8, with the F(x) embedding/extracting rule ID “#0”, a rule indicating that a value of F(x) is embedded in “lower x bits of a destination TID” is associated.

Returning back to FIG. 3, explanation is continued. The network interface 18 performs termination processing of unique layer 1, layer 2, and layer 3 protocols, and performs transmission and reception of a message with the mobile terminal 2, the eNB 6, or the S/P-GW 10. The network interface 18 is implemented by, for example, a network interface controller (NIC), and the like.

The communication-data processing unit 19 performs routing of a message that is transmitted and received by the allocation server 12, and various kinds of processing relating to a communication protocol that is used when a message is transferred, based on configuration information of communication paths. For example, when receiving a message addressed to a representative address of the MME 8 through the network interface 18, the communication-data processing unit 19 outputs the received message to the load-distribution processing unit 21.

Furthermore, when receiving a message addressed to the eNB 6 or the S/P-GW 10, the communication-data processing unit 19 outputs the received message to the destination through the network interface 18. Moreover, the communication-data processing unit 19 outputs a message received from the load-distribution processing unit 21 to the eNB 6, the S/P-GW 10, the data servers 15 to 17, and the like from the network interface 18. Furthermore, when receiving signaling information transmitted to the allocation server 12, the communication-data processing unit 19 outputs the signaling information to the communication-path control unit 20.

The communication-path control unit 20 performs various kinds of processing relating to load distribution by using the signaling information received by the allocation server 12. As for the processing relating to the load distribution, various kinds of processing performed in LTE and the like can be applied, and detailed explanation thereof is omitted.

The determining unit 28 determines, when receiving a message from the communication-data processing unit 19, whether a fixed identifier such as a user identifier is assigned to the received message. Moreover, when determining that a fixed identifier is assigned to the received message, the determining unit 28 calculates a hash value of the fixed identifier assigned to the message by using a predetermined hash function. The determining unit 28 outputs the message and the calculated hash value to the allocation unit 30. On the other hand, when a fixed identifier is not assigned to the received message, the determining unit 28 outputs the received message to the extracting unit 29.

The extracting unit 29 extracts a hash value of a fixed identifier from an interim identifier that is assigned to a message. For example, when receiving a message from the determining unit 28, the extracting unit 29 extracts a value of F(x) from an interim identifier assigned to the received message. For example, the extracting unit 29 identifies an F(x) embedding/extracting rule ID that is associated with a number of an application logical interface of an application from which the received message is transmitted from the rule specifying table 26. Subsequently, the extracting unit 29 identifies details of a rule that is associated with the F(x) embedding/extracting rule ID from the rule table 27. The extracting unit 29 extracts a value of F(x) from the interim identifier based on the details of the identified rule. The extracting unit 29 then outputs the extracted value of F(x) and the message to the allocating unit 30.

The allocating unit 30 allocates a received message. For example, when a hash value and a message are received from the determining unit 28, the allocating unit 30 refers to the hash-value allocation table 23, and identifies an allocation-destination data server ID that is associated with a hash value range including the received hash value. The allocating unit 30 then identifies an IP address that is associated with the identified allocation-destination data server ID from the allocation-destination managing table 24, and transmits the message accepted from the determining unit 28 addressing to the identified IP address.

For example, when receiving the hash value “X−5” from the determining unit 28, the allocating unit 30 identifies the allocation-destination data server ID “#α” that is associated with the hash range “0 to X” including the hash value “X−5”, from the hash-value allocation table 23. Subsequently, the allocating unit 30 identifies the IP address “a.b.c.d” that is associated with the allocation-destination data server ID “#α”, and transmits the message received from the determining unit 28 addressing to the identified IP address “a.b.c.d”.

On the other hand, when receiving a value of F(x) and a message from the extracting unit 29, the allocating unit 30 refers to the embedded-value managing table 25, and identifies an allocation-destination data server ID that is associated with an F(x) range including the received F(x) value. The allocating unit 30 then identifies an IP address that is associated with the identified allocation-destination data server ID from the allocation-destination managing table 24, and transmits the message received from the determining unit 28 addressing to the identified IP address.

For example, when receiving a value “h+1” of F(x) from the extracting unit 29, the allocating unit 30 identifies the allocation-destination data server ID “#β” that is associated with an F(x) value range “h+1 to i” including the value “h+1” of F(x) from the embedded-value managing table 25. Subsequently, the allocating unit 30 identifies the IP address “a.b.c.e” that is associated with the allocation-destination data server ID “#β” from the allocation-destination managing table 24, and transmits the message received from the determining unit 28 addressing to the identified IP address “a.b.c.e”.

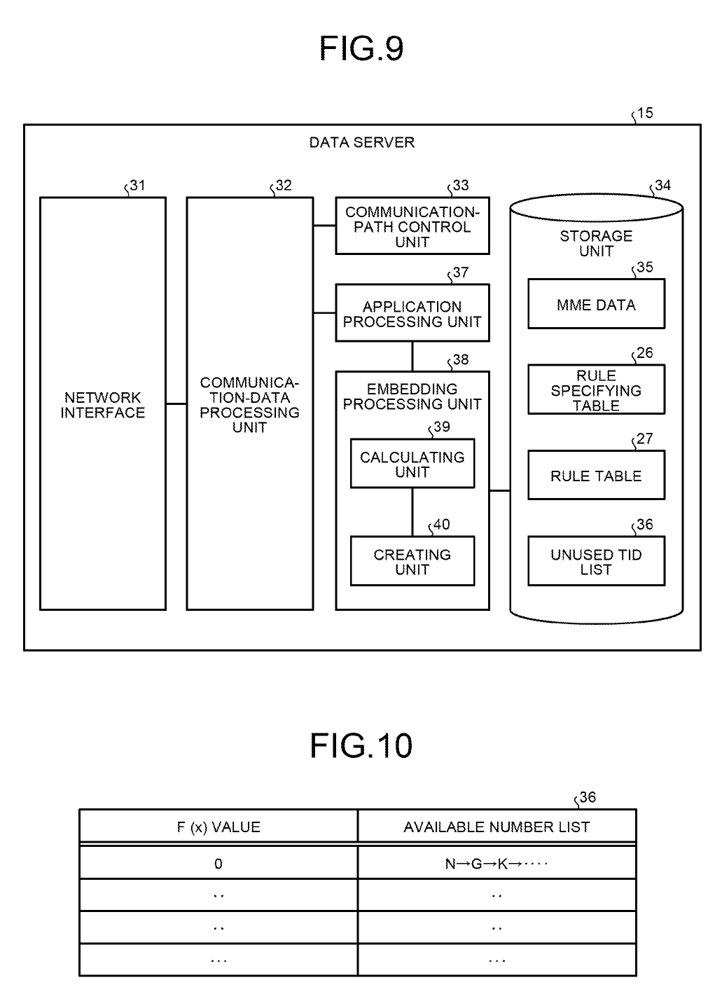

Next, one example of a functional configuration of the data server 15 is explained using FIG. 9. FIG. 9 is a block diagram depicting one example of a functional configuration of the data server. In the example depicted in FIG. 9, the data server 15, includes a network interface 31, a communication-data processing unit 32, a communication-path control unit 33, a storage unit 34, an application processing unit 37, and an embedding processing unit 38. Furthermore, in the storage unit 34, an MME data 35, the rule specifying table 26, the rule table 27, and an unused TID list 36 are stored. Moreover, the embedding processing unit 38 includes a calculating unit 39 and a creating unit 40.

In the following explanation, the network interface 31, the communication-data processing unit 32, the communication-path control unit 33 are supposed to have the same functions as the network interface 18, the communication-data processing unit 19, and the communication-path control unit 20 depicted in FIG. 3, and explanation thereof is omitted. Furthermore, in the following explanation, the MME data 35, the rule specifying table 26, the rule table 27, and the unused TID list 36 stored in the storage unit 34 are explained, and thereafter, processing performed by the application processing unit 37 and the embedding processing unit 38 is explained.

The MME data 35 is data for the data server 15 to function as an MME, and includes various kinds of information used to execute, for example, a network function application or an external-counterpart-network function application.

In the rule specifying table 26, for example information similar to that of the rule specifying table 26 explained using FIG. 7 is included. Moreover, in the rule table 27, for example information similar to that of the rule table 27 explained using FIG. 8 is included.

In the unused TID list 36, an interim identifier that is not used, that is, a value of an unused destination TID, is registered per a value of F(X) to be embedded in the destination TID. For example, FIG. 10 is a diagram for explaining one example of information that is stored in the unused TID list. In the example indicated in FIG. 10, in the unused TID list 36, a value of F(x) and an available number list are registered in an associated manner. The available number list is a list on which TIDs for which predetermined time has passed since an end of last use are registered out of destination TIDs including a value of F(x) associated therewith. For example, in the example indicated in FIG. 10, the unused TID list 36 indicates that destination TIDs including the F(x) value “0” are “N”, “G”, and “K”, and that “N”, “G”, and “K” are TIDs that have never been used or for which predetermined time or more has passed since an end of last use.

Returning back to FIG. 9, and explanation is continued. The application processing unit 37 executes a network function application, an external-counterpart-network function application, and the like by using information registered in the MME data 35, and the like. For example, when receiving a message through the communication-data processing unit 32, the application processing unit 37 extracts a fixed identifier or an interim identifier that is assigned to the received message. The application processing unit 37 then performs various kinds of processing to provide a continuous service by using the extracted fixed identifier or interim identifier, and creates service data as a result of performing the processing.

Moreover, the application processing unit 37 receives a message that includes a fixed identifier at the time of establishment of a signaling session. The application processing unit 37 then extracts a fixed identifier from the received message, and outputs the extracted fixed identifier and a number of a logical interface that is used when the data server 15 performs processing for the received message, to the embedding processing unit 38. Receiving the interim identifier from the embedding processing unit 38, the application processing unit 37 transmits service data to which the received interim identifier is assigned to the eNB 6, the S/P-GW 10, or the mobile terminal 2 to be a transmission source of the message. Thereafter, the application processing unit 37 continues the processing using the interim identifier received from the embedding processing unit 38 as for the same signaling session.

The calculating unit 39 calculates a hash value of the fixed identifier extracted by the application processing unit 37 using the predetermined hash function. More specifically, the calculating unit 39 calculates a hash value of the fixed identifier by using a hash function having an expression length according to the number of the data servers 15 to 17, that is the number of the data server 15 to 17 to be a subject of allocation of the message. For example, the calculating unit 39 uses a hash function that enables to calculate, from the fixed identifier, the number of hash value with which the message can be allocated to the respective data servers 15 to 17, or a hash value having a bit length with which the message can be allocated to the respective data server 15 to 17. For example, when receiving a fixed identifier from the application processing unit 37, the calculating unit 39 calculates a hash value of the fixed identifier by using a predetermined hash function. Subsequently, the calculating unit 39 identifies an F(x) embedding/extracting rule ID that is associated with a number of an application logical interface received from the application processing unit 37, from the rule specifying table 26. Subsequently, the creating unit 40 identifies details of the rule associated with the identified F(x) embedding/extracting rule ID from the rule table 27.

The calculating unit 39 then creates a value of F(x) according to the details of the rule identified from the rule table 27. For example, the calculating unit 39 outputs, when the details of the identified rule are “lower x bits of a destination TID”, the lower x bits out of the calculated hash value to the creating unit 40 as F(x).

The creating unit 40 creates a candidate of an interim identifier that includes the has value calculated by the calculating unit 39 in a part thereof. More specifically, the creating unit 40 performs the following processing per signaling session. First, the creating unit 40 creates a value of an interim identifier that includes the value of F(x) calculated by the calculating unit 39 in a position according to a communication protocol that is used when a message is transmitted and received by the application processing unit 37 in a value of the interim identifier.

For example, the creating unit 40 identifies an F(x) embedding/extracting rule ID that is associated with a number of an application logical interface received from the application processing unit 37 from the rule specifying table 26. Subsequently, the creating unit 40 identifies details of a rule that is associated with the identified F(x) embedding/extracting rule ID, from the rule table 27.

The creating unit 40 then creates, when receiving the value of F(x) calculated by the calculating unit 39, an interim identifier in which the value of F(x) is embedded, according to the details of the rule identified from the rule table 27. For example, the creating unit 40 stores the value of F(s) calculated by the calculating unit 39 in lower x bits, when the details of the identified rule are “lower x bits of a destination TID”, and creates a candidate of an interim identifier in which other data (for example, a random value) is stored in the other areas.

Subsequently, the creating unit 40 refers to the unused TID list 36, and determines whether the created candidate of the interim identifier is usable. For example, the creating unit 40 determines that the created candidate of the interim identifier is usable when the candidate is registered on the available number list associated with F(x) that is calculated by the calculating unit 39. That is, the creating unit 40 determines that the created candidate of the interim identifier is usable when a value of the created candidate of the interim identifier is included in TIDs for which predetermined time or more has passed since an end of last use.

The creating unit 40 then deletes the TID having the same value as the candidate of the interim identifier that is determined to be usable from the available number list associated with F(x) that is calculated by the calculating unit 39. The creating unit 40 outputs the usable candidate of the interim identifier to the application processing unit 37 as a created interim identifier.

Moreover, when an interim identifier is created, the creating unit 40 creates a new random number, if it is determined that the created candidate of the interim identifier is not usable, and creates a new candidate of an interim identifier by using the value of F(x) included in the candidate of the interim identifier and the newly created random number value. The creating unit 40 then determines whether the newly created candidate of the interim identifier is usable.

The creating unit 40 can embed a value of F(x) in an arbitrary position in an interim identifier. The embedding position may be set in advance, or may be set to a position according to a communication protocol that is used when a message is transmitted and received. For example, the creating unit 40 may embed a value of F(x) in lower x bits of an interim identifier for a message that is communicated with the eNB 6, and may embed a value of F(x) in upper x bits of an interim identifier for a message communicated with the S/P-GW 10. Furthermore, the creating unit 40 may embed a value of F(x) in different digits according to a communication protocol.

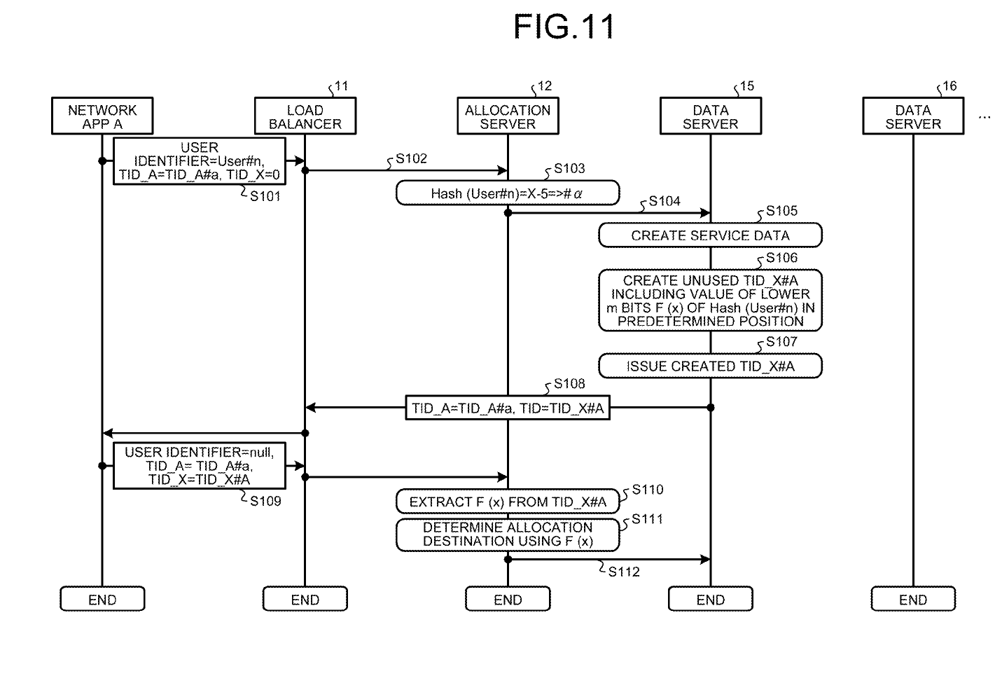

Next, one example of processing performed by the allocation server 12 and the data server 15 according to the first embodiment is explained using FIG. 11. FIG. 11 is a sequence diagram indicating one example of processing performed by the allocation server and the data server. In the example indicated in FIG. 11, one example of processing of allocating a message from the network app A executed by the eNB 6, by the load balancer 11, the allocation server 12, the data servers 15 and 16 is described.

In the following explanation, it is assumed that the allocation server 12 stores the various kinds of information indicated in FIG. 4 to FIG. 8, and the data server 15 stores the various kinds of information indicated in FIG. 7, FIG. 8, and FIG. 10. Moreover, in the following explanation, the allocation data server ID “#α” indicates the data server 15, and the allocation-destination data server ID “#β” indicates the data server 16.

For example, the network app A transmits a message including the user identifier “User#n”, TID_A “TID_A#a”, and TID_X “0” to the load balancer 11 (step S101). The load balancer 11 transfers the message to the allocation server 12 in accordance with a predetermined rule (step S102).

To the message transferred at step S102, the user identifier “User#n”, which is a fixed identifier, is assigned. Accordingly, when receiving the message, the allocation server 12 calculates a hash value “Hash (User#n)” of the user identifier “User#n” (step S103). For example, in the example indicated in FIG. 11, the allocation server 12 acquires the value “X−5” by calculation as the hash value “Hash (User#n)”. Therefore, the allocation server 12 identifies the allocation data server ID “#α” stored in association with a hash value range including the value “X−5”, from the hash-value allocation table 23. The allocation server 12 then transmits the received message to the data server 15 indicated by the identified allocation data server ID “#α” (step S104).

On the other hand, when receiving a message, the data server 15 performs processing to provide a service to create service data to be return to the network app A (step S105). Furthermore, the data server 15 calculates a value of the hash value “Hash (User#n)” of the user identifier “User#n”. Moreover, the data server 15 creates TID_X “TID_X#A” that is an unused interim identifier including F(x) being lower m bits of the calculated hash value “Hash (User#n)” in a predetermined position (step S106).

The data server 15 then issues TID_X “TID_X#A” to the network app A (step S107). More specifically, the data server 15 deletes the issued TID_X “TID_X#A” from TIDs that are associated with F(x) and registered on the unused TID list. The data server 15 then transmits TID_A “TID_A#a” and TID_X “TID_X#A” to the network app A together with the service data created at step S105 (step S108).

The network app A transmits the message, adding TID_A “TID_A#a” and TID_X “TID_X#A” thereto when further processing is to be executed, without adding the user identifier (step S109). In such a case, the allocation server 12 that receives the message through the load balancer 11 extracts the value of F(x) embedded in TID_X “TID_X#A” by referring to a rule specifying table 220 and a rule table 221 (step S110). The allocation server 12 then refers to the embedded-value managing table 25, and determines an allocation destination of the message by using the value of F(x), that is, a part of the hash value of the user identifier to be the transmission source of the message (step S111). The allocation server 12 then transfers the message to the determined allocation destination (step S112).

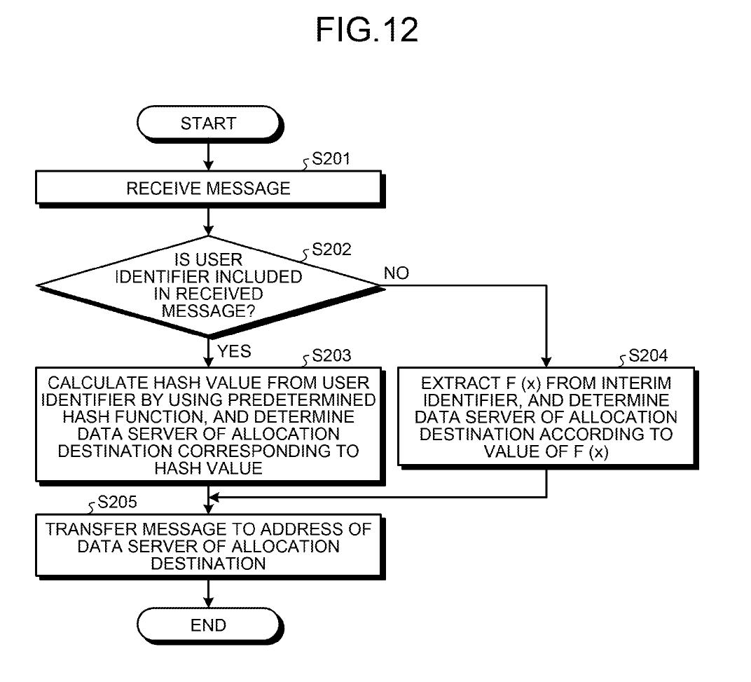

Next, a flow of processing performed by the allocation server 12 is explained using FIG. 12. FIG. 12 is a flowchart indicating one example of a flow of the processing performed by the allocation server. For example, when the allocation server 12 receives a message (step S201), the allocation server 12 determines whether a user identifier, that is, a fixed identifier, is assigned to the received message (step S202). When a user identifier is assigned to the message (step S202: YES), the allocation server 12 calculates a hash value from a value of the user identifier by using a predetermined hash function, and determines a data server to be an allocation destination corresponding to the hash value (step S203). The allocation server 12 then transfers the received message to the determined data server of the allocation destination (step S205), and ends the processing.

On the other hand, when a user identifier is not assigned to the message (step S202: NO), the allocation server 12 refers to the rule specifying table 220 and the rule table 221, and extracts a value of F(x) from an interim identifier. The allocation server 12 then determines a data server to be an allocation destination according to the extracted value of F(x) (step S204). The allocation server 12 then performs the processing indicated at step S205.

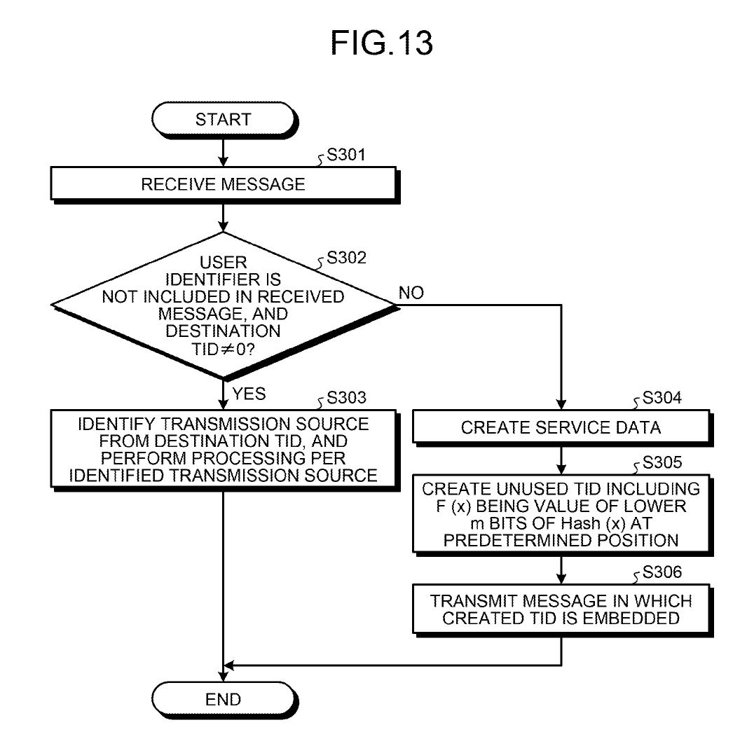

Next, a flow of processing performed by the data server 15 is explained using FIG. 13. FIG. 13 is a flowchart indicating one example of a flow of the processing performed by the data server. For example, when a message is received (step S301), the data server 15 determines whether a user identifier is not present in the received message, and a value of a destination TID is other than 0 (null) (step S302).

When a user identifier is not assigned to the received message and the value of the destination TID is other than 0 (null) (step S302: YES), the data server 15 then performs the following processing. First, the data server 15 identifies a transmission source from a value of the destination TID, and performs data processing per identified transmission source (step S303), and ends the processing. That is, when a fixed identifier is not included in the message but an interim identifier issued to the transmission source is included therein, the data server 15 continues processing, such as creation of service data, in a signaling session indicated by the interim identifier.

On the other hand, when a user identifier is assigned in the received message, or when the value of the destination TID is 0 (null) (step S302: NO), the data server 15 performs the following processing. First, the data server 15 creates service data (step S304). Subsequently, the data server 15 calculates a hash value “Hash (User#n)” of the fixed identifier “User#n”, and creates an unused TID that includes F(x) in a predetermine position, using lower m bits of the calculated hash value as F(x) (step S305). The data server 15 then transmits a response message in which the TID created at step S305 is embedded (step S306), and ends the processing.

### Effects of First Embodiment

As described above, when receiving a message from the network app A, the data server 15 extracts a user identifier, which is a fixed identifier, from the received message. Moreover, the data server 15 calculates a hash value of the extracted user identifier by using a predetermined hash function. Subsequently, the data server 15 creates an interim identifier that is different per signaling session, that is a value including a part of the hash value of the user identifier and a random value,

As are result, even if a fixed identifier is not included in a message, the allocation server 12 can guarantee the uniqueness of a data server to be an allocation destination of the message. Therefore, the data server 15 can execute a network function application for processing a single signaling session in different systems in a coordinated manner in a scale-out cluster system.

Furthermore, the data server 15 calculates a hash value of a fixed identifier by using a hash function to calculate a hash value having an expression length according to the number of data servers to which a processing execution request is allocated. Therefore, the data server 15 can allocate a message to the respective data servers 15 to 17 included in the MME 8, and therefore, waste of resources can be suppressed.

Moreover, the data server 15 creates an interim identifier in which a value of F(x) is embedded in a position according to a communication protocol used when a message is transmitted and received. Therefore, the data server 15 can execute a network function application in a scale-out cluster system also when a message is transmitted and received using multiple communication protocols.

Furthermore, the data server 15 creates an interim identifier the value of which differs per signaling session. Therefore, the data server 15 can execute a network function application that processes multiple signaling sessions in a scale-out cluster system.

Moreover, when an interim identifier is included in a received message, the data server 15 performs predetermined processing using the interim identifier. Therefore, the data server 15 can provide a continuous service based on the message transmitted and received in a series of signaling sessions.

Furthermore, the data server 15 determines that an interim identifier for which predetermined time has passed since an end of last use as a usable interim identifier. Therefore, the data server 15 can reduce a risk of causing a malfunction in services.

For example, a case in which an interim identifier X that has been used by a user A is assigned to another user B soon after a service for the user A is finished is considered. In that case, it can enable the user B to see communication of the user A. Moreover, a malicious third user C recognizing that the interim identifier X is being used can use the stolen interim identifier X to start communication, and disturb the service for the user B by disconnecting, or the like. However, the data server 15 of the present embodiment enables an interim identifier to be used when predetermined time or more has passed since an end of last use of the interim identifier. Therefore, the communication of the user C in a period before the predetermined time passes from when the use thereof is ended is recognized as unauthorized or abnormal communication. Accordingly, the data server 15 of the present embodiment can avoid a detrimental effect on a service for other proper users.

Moreover, when inconsistency in a control condition is caused by loss of a message or disagreement in communication procedures on a transmission side and a reception side, it is recognized that a service for the user A is finished in a system that provides the service, while it is recognized that the service is continued in the user A. In such a case, the user A interferes with the service for the user B by keep using the interim identifier X that has already been assigned to the user B. However, the data server 15 can take sufficient time in which the interim identifier X is not used by performing the processing described above, and therefore, can avoid a detrimental effect on a service for other proper users.

### [b] Second Embodiment

For example, there is a case in which the data server 15 requests execution of processing to a network app B that is different from the network app A when receiving a message from the network app A, and transmits a result of execution of the processing by the network app B to the network app A. However, when such processing is performed, it has been difficult to allocate a message from the network app B to a data server that has requested the processing to the network app B in a related cluster system, and has been difficult to continue the service.

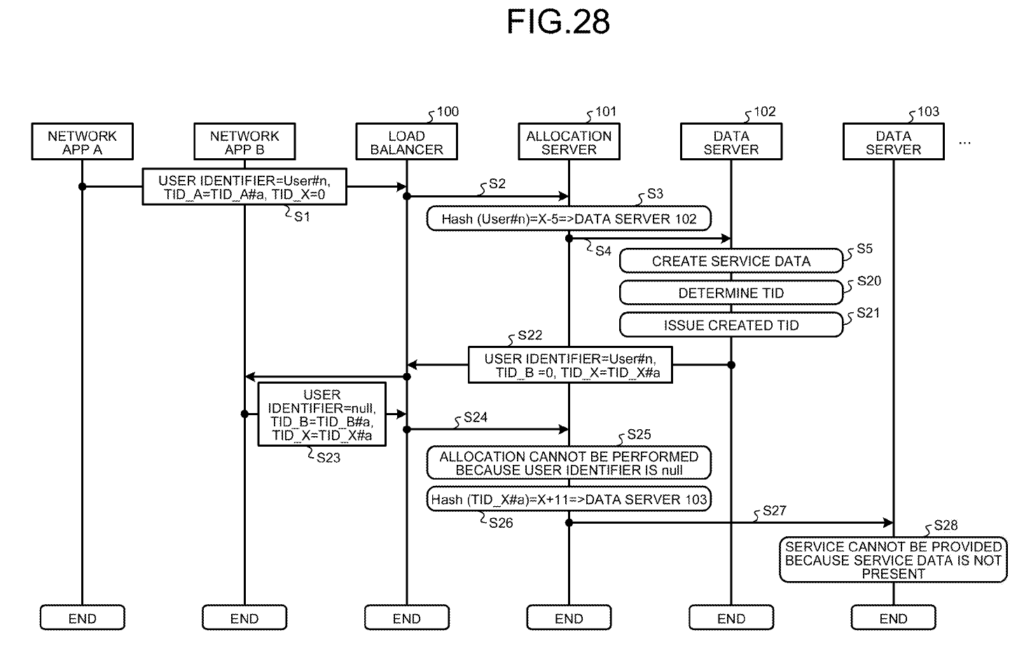

For example, FIG. 28 is a sequence diagram indicating a second example of processing performed by the related allocation server and data server. In the example indicated in FIG. 28, one example of processing of the related cluster system of requesting processing to the network app B when a message is received from the network app A, and of transmitting a processing execution result received from the network app B to the network app A is indicated. Among the processing indicated in FIG. 28, to processing same as the processing indicated in FIG. 27, a reference symbol identical thereto is assigned, and explanation thereof is omitted.

For example, when receiving a message from the network app A, the data server 102 determines a value of TID_X to be used for communication with the network app B (step S20). The data server 102 outputs the determined TID_X to the network app B (step S21). More specifically, the data server 102 transmits the user identifier “User#n” and TID_X “TID_X#a” to the network app B together with the service data that is created at step S5 (step S22). TID_B indicated at step S22 is an interim identifier that is created by the network app B, and a value “0” is included therein at the point of step S22.

In that case, the network app B creates TID_B “TID_B#a”, and transmits TID_B “TID_B#a” and TID_X “TID_X#a” created at step S22 to the load balancer 100 together with an execution result (step S23). The load balancer 100 transfers the received message to the allocation server 101 (step S24).

Because a user identifier is not included in the message transmitted at step S23, it is difficult for the allocation server 101 to perform allocation using a user identifier (step S25). Therefore, the allocation server 101 calculates a hash value of TID_X “Hash (TID_X#a)”. However, because the value of TID_X is a different value from the user identifier, in the example indicated in FIG. 28, the allocation server 101 calculates a value “X+11” as the hash value “Hash (TID_X#a)” (step S26).

As a result, the allocation server 101 transmits the received message to the data server 103 (step S27). However, because the data server 103 does not store therein the service data created at step S5, even if the execution result is received from the network app B, it is difficult for the data server 103 to provide a service to the network app A (step S28).

Therefore, the data server 15a according to a second embodiment performs following management processing. The data server 15a creates, when receiving an execution request of processing that is performed by using multiple external systems, an interim identifier having a different value per external system. The data server 15a then performs communication with the respective external systems by using the interim identifier created per external system.

Moreover, the data server 15a creates, when transmission and reception of packets using different communication protocols in a series of signaling sessions occur, an interim identifier having an expression length according to each communication protocol. In this case, to each interim identifier, a part of a hash value calculated from a fixed identifier F(x) is included in common. Furthermore, the data server 15a uses a bit number of a length that can be included in either of the interim identifiers of the communication protocols used in a series of signaling sessions, as a bit number of F(X). That is, the bit number of F(x) is less than a bit number of either one of the interim identifiers of the communication protocols used in a series of signaling sessions. Thus, the data server 15a can include F(x), which is a part of the hash value calculated from the fixed identifier, in different fixed identifiers that are used in respective signaling sessions in common. Accordingly, the data server 15a can guarantee the uniqueness of an allocation destination of a message even when bit lengths of interim identifiers used in the respective communication protocols differ.

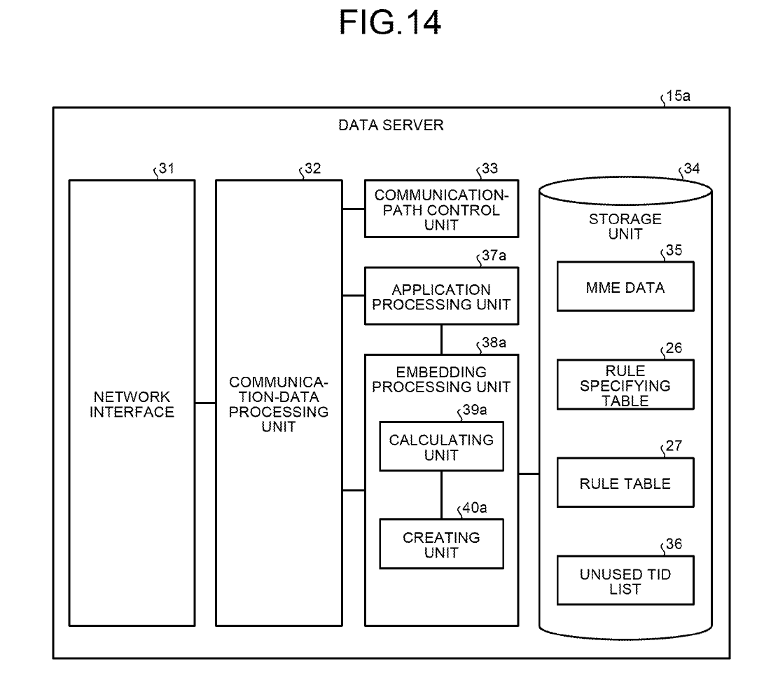

Next, one example of a functional configuration of the data server 15a is explained using FIG. 14. FIG. 14 is a block diagram depicting one example of a functional configuration of the data server according to the second embodiment. In the example depicted in FIG. 14, the data server 15a includes the network interface 31, the communication-data processing unit 32, the communication-path control unit 33, the storage unit 34, an application processing unit 37a, and an embedding processing unit 38a. Moreover, the embedding processing unit 38a includes a calculating unit 39a and a creating unit 40a.

The application processing unit 37a has the same function as that of the application processing unit 37 depicted in FIG. 9. More specifically, the application processing unit 37a transmits and receives a message with multiple external systems (for example, a network app) in a series of signaling sessions, and performs processing based on the message in coordination with respective network apps. The application processing unit 37a informs, at the time of establishment of a series of signaling sessions, information about a communication protocol that is used by an external system when performing transmission and reception of a message in the sessions. The application processing unit 37a acquires an interim identifier per communication protocol of external systems from the embedding processing unit 38a, and performs transmission and reception of a message with the respective external systems by the respective communication protocols, using the acquired interim identifier.

For example, when processing for a message received from the network app A is, for example, a request the network app B to perform processing, the application processing unit 37a transmits the message to the network app B using the interim identifier that is acquired by the embedding processing unit 38a. When an execution result of processing is received from the network app B, the application processing unit 37a performs processing using the received execution result and transmits an execution result of the processing using the interim identifier that is acquired from the embedding processing unit 38a.

The calculating unit 39a has a similar function as that of the calculating unit 39 depicted in FIG. 9. More specifically, when information about communication protocols of external systems is informed along with a fixed identifier by the application processing unit 37a, the calculating unit 39a calculates a hash value of the fixed identifier. The calculating unit 29a then identifies a bit number that can be included in the interim identifier of either one of the communication protocols informed by the application processing unit 37a. The calculating unit 39a extracts the identified bit number in the calculated hash value as F(x). The calculating unit 39a then outputs the value of extracted F(x) to the creating unit 40a.

The creating unit 40a performs similar processing as the creating unit 40 depicted in FIG. 9, and creates different interim identifiers as many as the number of the external systems that performs processing for the message. More specifically, the creating unit 40a creates an interim identifier in which the value of F(x) calculated by the calculating unit 39a is included in a position according to a communication protocol used when a message is transmitted and received by the application processing unit 37a in a value of the interim identifier. At that time, if the value of the created interim identifier is not registered on the unused TID list 36 associated with F(x) included in the interim identifier, the creating unit 40a recreates an interim identifier.

For example, the creating unit 40a identifies information associated with an application logical interface of an external system to be a transmission destination of the message from the rule specifying table 26 and the rule table 27. The creating unit 40a creates an interim identifier using the information identified from the rule specifying table 26 and the rule table 27. The creating unit 40a then deletes a value of the created interim identifier from the unused TID list 36.

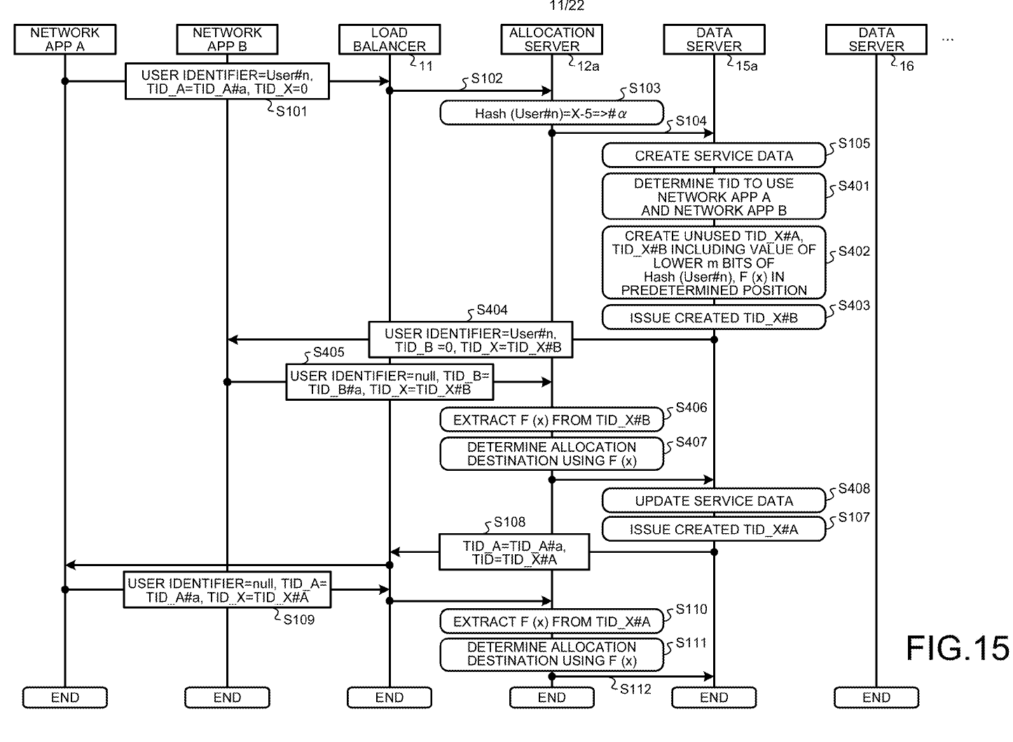

Next, a flow of processing performed by the allocation server 12a and the data server 15a is explained using FIG. 15. FIG. 15 is a sequence diagram indicating one example of processing performed by an allocation server and the data server according to the second embodiment. Among processing indicated in FIG. 15, to processing similar to the processing indicated in FIG. 11, a reference symbol identical thereto is assigned, and explanation thereof is omitted.

For example, when creating service data, the data server 15a determines TID to use the network app A and the network app B (step S401). For example, the data server 15a calculates a hash value of a fixed identifier. The data server 15a then identifies a bit number that can be included in an interim identifier of either one of communication protocols of the network app A and the network app B. The data server 15a then extracts the identified bit number (for example, lower m bits) out of the calculated hash value as F(x). The data server 15a then creates TID_X “TID_X#A” and TID_X “TID_X#B” that have not been used and that include the value of the lower m bits of “Hash(User#n)”, F(x) in a predetermined position thereof (step S402). Subsequently, the data server 15a outputs the created TID_X “TID_X#B” to the network app B (step S403). More specifically, the data server 15a transmits the user identifier “(User#n” and TID_X “TID_X#B” to the network app B along with the service data created at step S105 (step S404).

The network app B outputs a message obtained by adding TID_D “TID_X#D” and TID_X “TID_X#B” to a processing execution result (step S405). The allocation server 12a refers to the rule specifying table 26 and the rule table 27, and extracts a value of F(x) from a value of TID_X “TID_X#B” (step S406). The allocation server 12a then determines the data server 15a as an allocation destination according to the value of F(x), and transmits the message received from the network app B to the data server 15a (step S407).

On the other hand, when the message from the network app B is received, the data server 15a updates service data using the execution result of performed by the network app B (step S408). The data server 15a then outputs TID_X “TID_X#A” that has been created at step S402 to the network app A along with the updated service data (step S107). The data server 15a communicates with the network app A using TID_X “TID_X#A” being the interim identifier, and can provide a continuous service.

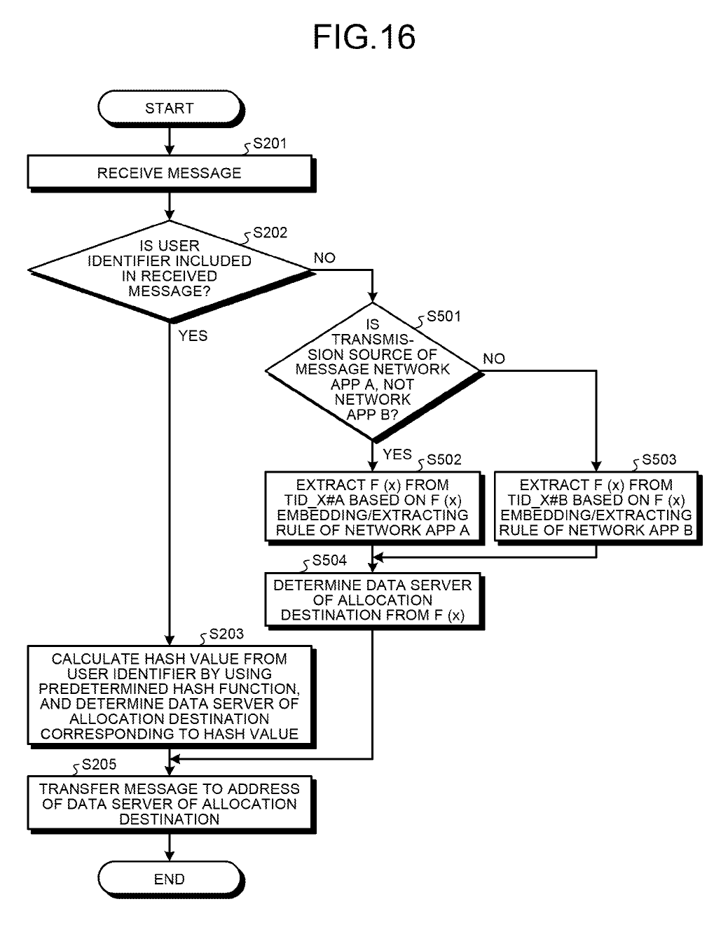

Next, a flow of processing performed by the allocation server 12a is explained using FIG. 16. FIG. 16 is a flowchart indicating one example of a flow of processing performed by the allocation server according to the second embodiment. Among processing indicated in FIG. 16, to processing similar to the processing indicated in FIG. 27, a reference symbol identical thereto is assigned, and explanation thereof is omitted.

For example, when a user identifier is not included in a received message (step S202: NO), the allocation server 12a determines whether that a transmission source of the message is the network app A, not the network app B (step S501). When the transmission source of the message is the network app A not the network app B (step S501: YES), the allocation server 12a performs following processing. That is, the allocation server 12a refers to the rule specifying table 26 and the rule table 27, and extracts a value of F(x) from the value of TID_X “TID_X#A” based on an F(x) embedding rule for the network app A (step S502). Subsequently, the allocation server 12a refers to the embedded-value managing table 25, and determines a data server to be the allocation destination from the extracted value of F(x) (step S504). The allocation server 12a then performs the processing indicated at step S205.

On the other hand, when the transmission source of the message is the network app B not the network app A (step S501: NO), the allocation server 12a refers to the rule specifying table 26 and the rule table 27, and extracts a value of F(x) from the value of TID_X “TID_X#B” based on an F(x) embedding/extracting rule for the network app B (step S503). The allocation server 12a then performs the processing indicated at step S504.

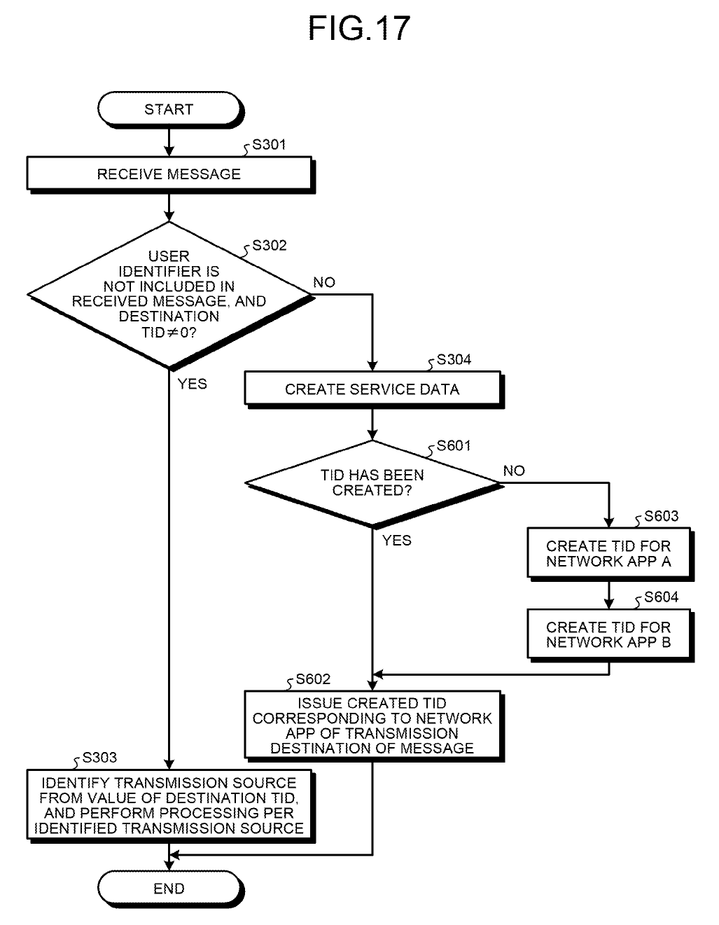

Next, a flow of processing performed by the data server 15a is explained using FIG. 17. FIG. 17 is a flowchart indicating one example of a flow of processing performed by the data server according to the second embodiment. Among processing indicated in FIG. 17, to processing similar to the processing indicated in FIG. 13, a reference symbol identical thereto is assigned, and explanation thereof is omitted.

For example, when creating service data (step S304), the data server 15a determines whether TID corresponding to a transmission destination of a message has been created (step S601). When TID has been created (step S601: YES), the data server 15a outputs TID that has been created and corresponds to a network app of the transmission destination of the message (step S602).

On the other hand, when TID corresponding to a transmission destination of the message has not created yet (step S601: NO), the data server 15a creates TID for the network app A (step S603). Subsequently, the data server 15a creates TID for the network app B (step S604). The data server 15a then performs the processing indicated at step S602.

### Effects of Second Embodiment

As described above, the data server 15a creates, when receiving an execution request of processing that is performed using multiple external systems, interim identifiers having a different value per external system. The data server 15a then communicates with the respective external systems using the interim identifiers created for the respective external systems. Therefore, the data server 15a can guarantee the uniqueness of a transfer destination of each message even when processing is performed in coordination with multiple external systems.

Moreover, the data server 15a creates an interim identifier in which a value of F(x) is embedded in a position according to a communication protocol used when a message is transmitted and received in the interim identifier. Therefore, the data server 15a can guarantee the uniqueness of an allocation destination of a message even when a method of referring an interim identifier differs according to a communication protocol.

Furthermore, the data server 15a calculates F(x) that is a part of a hash value calculated from a fixed identifier in a bit number that can be included in interim identifiers having expression lengths according to communication protocols that are used by respective external systems. Thus, the data server 15a can prevent a part of a hash value included in an interim identifier that is used in one communication protocol from exceeding from a bit number of an interim identifier that is used in the other communication protocol, in a series of signaling sessions. Therefore, the data server 15a can guarantee the uniqueness of an allocation destination of a message even when bit lengths of interim identifiers used in the respective communication protocols differ, in the series of signaling sessions.

### [c] Third Embodiment

A data server 15b of the present embodiment redirects communication with a transmission source of a message to another representative address when all usable interim identifiers have been issued and no unused interim identifier is available. For example, in the data server 15b, different hash functions are associated with respective representative addresses. When no unused interim identifier is available, the data server 15b calculates F(x) that is a part of a hash value calculated from a fixed identifier using another hash function. Subsequently, the data server 15b determines whether an unused interim identifier that includes calculated F(x) is present among TIDs usable in the own device. When an unused interim identifier among TIDs that are usable in the own device is present, the data server 15b informs a representative address that is associated with the has function used for calculation of F(x) to the transmission source of the message, thereby redirecting to the transmission source. Thus, the external system of the transmission source can receive allocation of an interim identifier, by redirecting to the informed representative address.

Moreover, when an unused interim identifier is not present among TIDs usable in the own device, the data server 15b send an inquiry, along with a fixed identifier and information about the transmission source of the message, whether an allocatable interim identifier based on the fixed identifier is present, to another data server. The other data servers that receives the inquiry calculates a part of a hash value F(x) from the informed fixed identifier using a hash function of each representative address assigned to the own device. The other data server that receives the inquiry determines whether an unused interim identifier including the calculated F(x) for each representative address is present among TIDs usable in the own device. When an unused interim identifier is present among TIDs usable in the own device, the other data server informs a representative address that is associated with the hash function used for calculation of F(x) to the transmission source of the message, thereby redirecting to the transmission source. Thus, the external system of the transmission source can receive allocation of an interim identifier, by redirecting to the informed representative address.

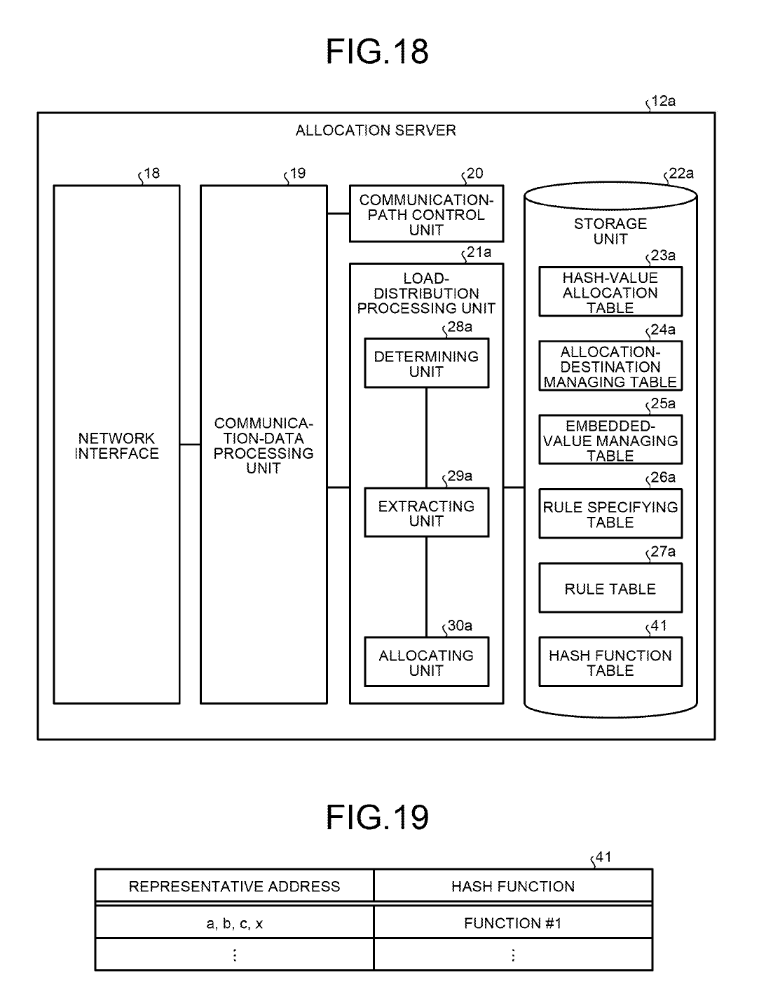

The allocation server 12a and the data server 15b according to the third embodiment are explained below. One example of a functional configuration of the allocation server 12a is explained using FIG. 18. FIG. 18 is a block diagram depicting one example of a functional configuration of the allocation server according to the third embodiment.

In the example depicted in FIG. 18, the allocation server 12a includes the network interface 18, the communication-data processing unit 19, the communication-path control unit 20, a load-distribution processing unit 21a, and a storage unit 22a. Moreover, the storage unit 22a includes a hash-value allocation table 23a, an allocation-destination managing table 24a, an embedded-value managing table 25a, a rule specifying table 26a, a rule table 27a, and a hash function table 41. Furthermore, the load-distribution processing unit 21a includes a determining unit 28a, an extracting unit 29a, and an allocating unit 30a.

First, information stored in the storage unit 22a is explained. In the hash-value allocation table 23a, for example, information similar to that of the hash-value allocation table 23 depicted in FIG. 4 is registered per representative address assigned to the allocation server 12a. In the allocation-destination managing table 24a, for example, information similar to that of the allocation-destination managing table 24 depicted in FIG. 5 is registered per representative address assigned to the allocation server 12a. In the embedded-value managing table 25a, for example, information similar to that of the embedded-value managing table 25 depicted in FIG. 6 is registered per representative address assigned to the allocation server 12a. In the rule specifying table 26a, for example, information similar to that of the rule specifying table 26 depicted in FIG. 6 is registered per representative address assigned to the allocation server 12a. In the rule table 27a, for example, information similar to that of the rule table 27 depicted in FIG. 8 is registered per representative address assigned to the allocation server 12a.

Moreover, in the hash function table 41, a hash function that is used when calculating a value of F(x) from a fixed identifier is stored per representative address assigned to the allocation server 12a. For example, FIG. 19 depicts one example of information that is stored in the hash function table. In the example depicted in FIG. 19, in the hash function table 41, an IP address that is a representative address assigned to the allocation server 12a, and a hash function that is used when receiving a message address to the IP address are registered in an associated manner. For example, in the example depicted in FIG. 19, an IP address “a.b.c.x” and a hash function “function #1” are registered in an associated manner in the hash function table 41.

The determining unit 28a has a function similar to that of the determining unit 28. More specifically, the determining unit 28a calculates a hash value of a fixed identifier by using a hash function according to a representative address assigned to the allocation server 12a, similarly to the determining unit 28. For example, the determining unit 28a identifies a hash function that is associated with the representative address assigned to the allocation server 12a. The determining unit 28a then calculates a hash value of a fixed identifier by using the identified hash function.

The extracting unit 29a performs processing similar to that of the extracting unit 29. More specifically, the extracting unit 29a identifies information that is associated with the representative address assigned to the allocation server 12a from the rule specifying table 26a and the rule table 27a. Moreover, the extracting unit 29a identifies details of a rule that is associated with a number of an application logical interface that is used when processing for a message is performed. The extracting unit 29a then extracts a value of F(x) from an interim identifier according to the details of the rule.

The allocating unit 30a performs processing similar to that of the allocating unit 30. More specifically, the allocating unit 30a identifies information that is associated with the representative address assigned to the allocation server 12a from the hash-value allocation table 23a, the allocation-destination managing table 24a, and the embedded-value managing table 25a. Subsequently, the allocating unit 30a allocates the received message using the identified information. That is, the allocating unit 30 allocates the message using a hash function that is different per representative address assigned to the allocation server 12a.

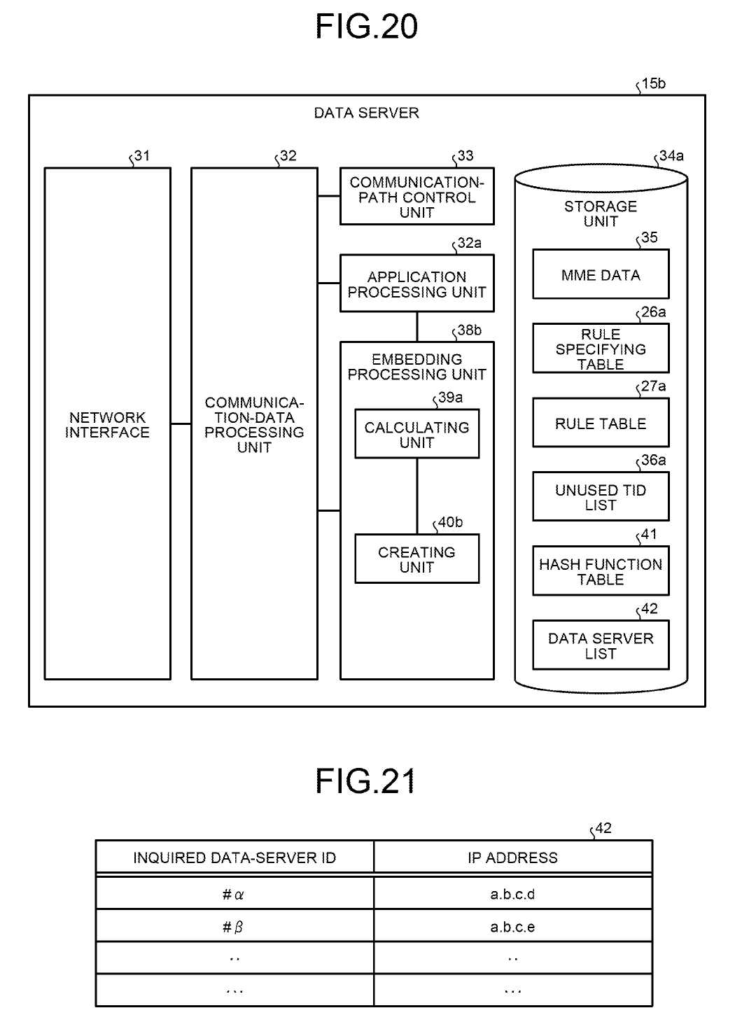

Next, one example of a functional configuration of the data server 15b is explained using FIG. 20. FIG. 20 is a block diagram depicting one example of a functional configuration of the data server according to the third embodiment. In the example depicted in FIG. 20, the data server 15b includes the network interface 31, the communication-data processing unit 32, the communication-path control unit 33, the application processing unit 37a, an embedding processing unit 38b, and a storage unit 34a. Moreover, the storage unit 34a includes the MME data 35, the rule specifying table 26a, the rule table 27a, an unused TID list 36a, the hash function table 41, and data server list 42. Furthermore, the embedding processing unit 38b include the calculating unit 39a and a creating unit 40b.

In the data server list 42, an IP address to send an inquiry to another data server (for example, the data servers 16 and 17 depicted in FIG. 1) to be an allocation destination of a message is registered. For example, FIG. 21 depicts one example of information that is stored in the data server list. As depicted in FIG. 21, in the data server list 42, an inquired data-server ID that is an identifier of a data server to be inquired, and an IP address of the data server are registered in an associated manner. For example, in the example depicted in FIG. 21, an inquired data-server ID “#α” and the IP address “a.b.c.d” are registered in an associated manner, and an inquired data-server ID “#β” and the IP address “a.b.c.e” are registered in an associated manner.

Returning back to FIG. 20, explanation is continued. The calculating unit 39a has a function similar to that of the calculating unit 39a depicted in FIG. 14. More specifically, the calculating unit 39a refers to the hash function table 41, and identifies a hash function that is associated with the representative address. Subsequently, the calculating unit 39a calculates a hash value by using the identified hash function, and extracts F(x) from the calculated hash value.

The creating unit 40b has a function similar to that of the creating unit 40 or the creating unit 40a. More specifically, the creating unit 40b refers to information corresponding to the representative address among information registered in the unused TID list 36a, and determines whether an unused TID that is associated with the value of F(x) calculated by the calculating unit 39a is present. When an unused TID is not present, the creating unit 40b refers to the hash function table 41, and selects a hash function that is different from the hash function used when calculating the value of F(x). The creating unit 40b then instructs the calculating unit 39a to calculate F(x) by using the selected hash function. When an unused TID that is associated with the value of F(x) calculated by the calculating unit 39a is found in the unused TID list 36a, the creating unit 40b identifies a representative address associated with the hash function that is used when calculating the F(x). Subsequently, the creating unit 40b informs the identified representative address to the transmission source of the message, thereby redirecting to the informed representative address.

On the other hand, when an unused TID is not found even by using either one of the hash functions registered in the hash function table 41 of the own device, the creating unit 40b refers to the data server list 42, and identifies IP addresses of all data servers. The creating unit 40b transmits a message of inquiring whether an allocatable interim identifier based on the fixed identifier is present, along with a fixed address and information of the transmission source of the message, addressing to the identified IP address. The creating unit 40b of another data server that receives the inquiry refers to the hash function table 41, and instructs the calculating unit 39a to calculate F(x) using a hash function per representative address assigned to the own device. The creating unit 40b of the other data server that receives the inquiry determines whether an unused interim identifier including calculated F(x) per representative address is present among TIDs usable in the own device. When an unused interim identifier is present, the creating unit 40b of the other data server that receives the inquiry informs a representative address that is associated with the hash function used for calculation of the F(x) to the transmission source of the message, thereby redirecting to the transmission source.

On the other hand, when an unused interim identifier is not present among TIDs usable in the own device, the creating unit 40b of the other data server that receives the inquiry informs the data server 15b of the transmission source of the inquiry of failure in allocation of an interim identifier. When failure in allocation is informed from all other data servers, the data server 15b transmits a message indicating failure in establishing a session, and of guiding redirection to a system that provides a similar kind of service to the service provided by the MME 8.

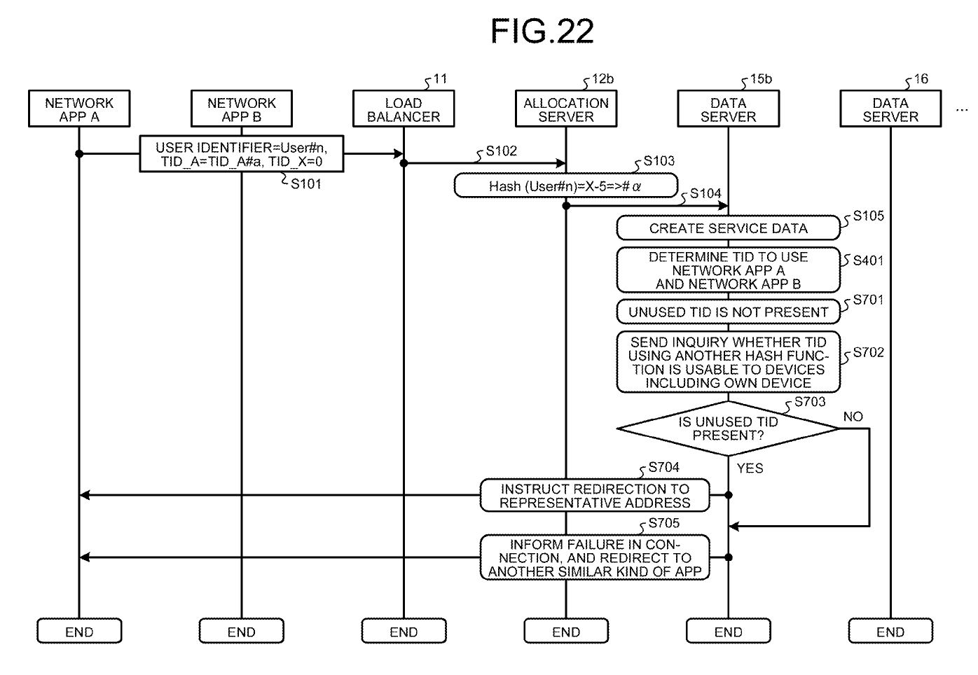

Next, a flow of processing performed by the allocation server 12a and the data server 15b is explained using FIG. 22. FIG. 22 is a sequence diagram indicating one example of processing performed by the allocation server and the data server according to the third embodiment. Among the processing indicated in FIG. 22, to processing similar to the processing indicated in FIG. 11 and FIG. 15, a reference symbol identical thereto is assigned, and explanation thereof is omitted.

For example, the data server 15b performs following processing when an unused TID including a value of F(x) calculated based on a fixed identifier is not present (step S701). That is, the data server 15b inquires all of data servers including the own device whether an unused TID including F(x) that is calculated by using another hash function is present (step S702). When an unused TID is present among TIDs including F(x) calculated by using the other hash function (step S703: YES), the data server 15b transmits an instruction to redirect to another representative address, to the network app A (step S704). On the other hand, when an unused TID including F(x) calculated by using the other hash function is not present (step S703: NO), the data server 15b performs following processing. That is, the data server 15b transmits a message of guiding redirection to another similar kind of app, along with a message indicating failure in establishing a session, to the network app A (step S705).

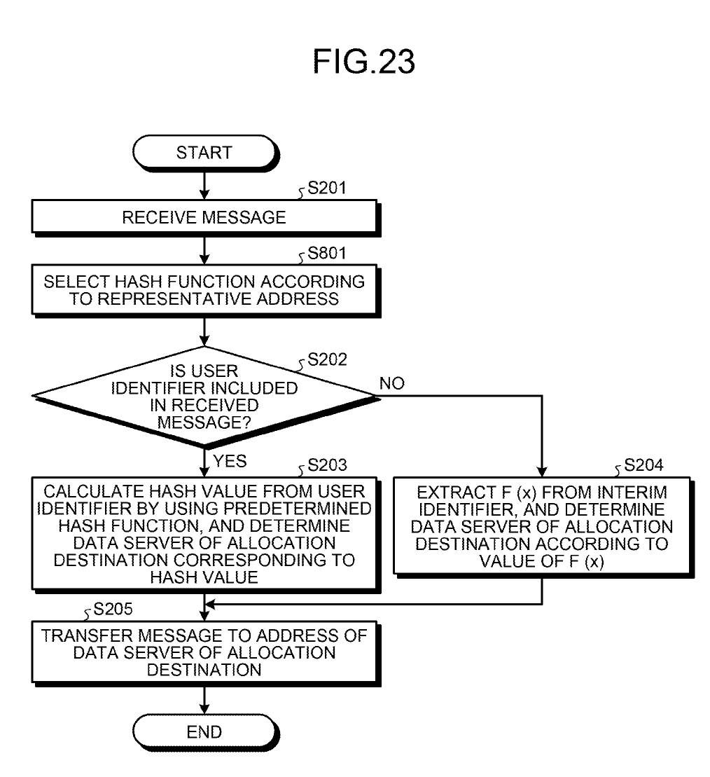

Next, a flow of processing performed by the allocation server 12a is explained using FIG. 23. FIG. 23 is a flowchart indicating one example of a flow of processing performed by the allocation server according to the third embodiment. Among the processing indicated in FIG. 23, to processing similar to the processing indicated in FIG. 12, a reference symbol identical thereto is assigned, and explanation thereof is omitted.

For example, when receiving a message (step S″01), the allocation server 12a selects a hash function that is associated with a representative address of a destination of the message (step S801). The allocation server 12b performs processing indicated at steps S202 to S205 by using the selected hash function.

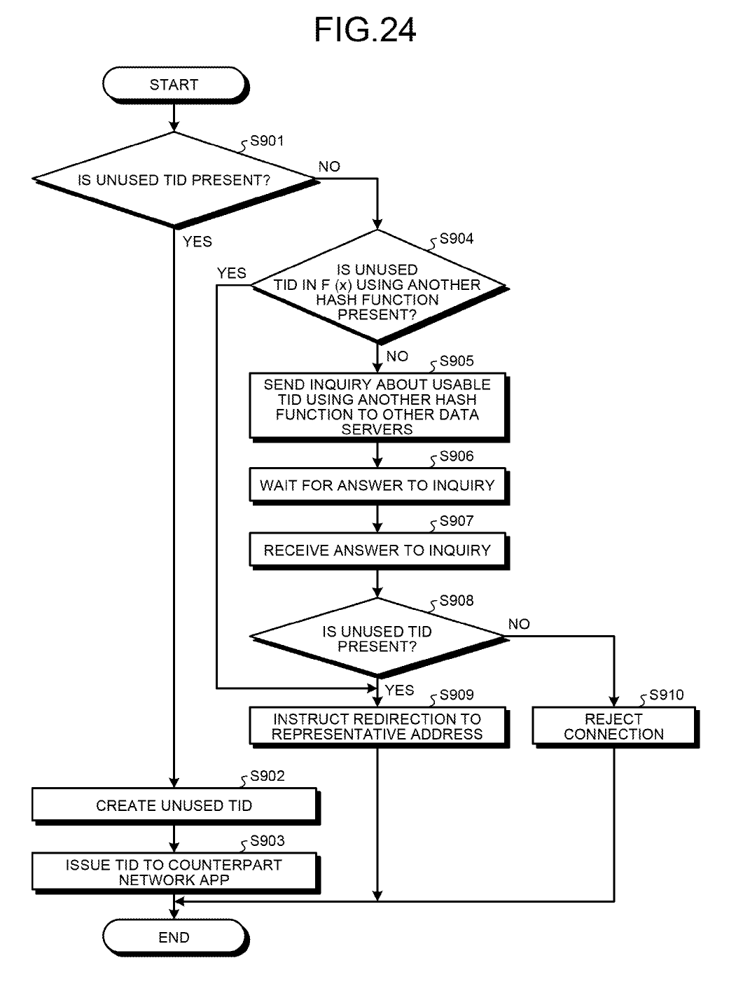

Next, a flow of processing performed by the data server 15b is explained using FIG. 24. FIG. 24 is a flowchart indicating one example of a flow of the processing performed by the data server according to the third embodiment. In FIG. 24, a flow of processing of the data server 15b, according to whether an unused TID including F(x) that is calculated based on a fixed identifier is present is described.

For example, the data server 15b determines whether an unused TID including a value of F(x) that is calculated based on a fixed identifier is present (step S901). When an unused TID including F(x) that is calculated based on the fixed identifier is present (step S901: YES), the data server 15b performs following processing. That is, the data server 15b creates a candidate of TID including F(x), and if the created candidate of TID is an unused TID, creates the candidate as TID (step S902). Subsequently, the data server 15b outputs the created TID to a network app on a counterpart side (step S903), and ends the processing.

On the other hand, when an unused TID including F(x) that is calculated based on the fixed identifier is not present (step S901: NO), the data server 15b determines whether an unused TID including F(x) that is calculated by using another hash function is present among TIDs usable in the own device (step S904). When an unused TID including F(x) that is calculated by using the other hash function is present among TIDs usable in the own device (step S904: YES), the data server 15b performs following processing indicated at step S909.

On the other hand, when a used TID is not present in the own device (step S904: NO), the data server 15b inquires other data servers whether an unused TID including F(x) that is calculated by using another hash function is present in the other data servers (step S905).

The data server 15b waits for an answer to the inquiry (step S906), and receives answers to the inquiry from all of the other data servers (step S907). When informed that an unused TID is present from either one of the other data servers (step S908: YES), the data server 15b performs following processing. That is, the data server 15b transmits, to the transmission source of the message, an instruction to redirect to a representative address that is associated with the other hash function (step S909), and ends the processing.

On the other hand, when informed that an unused TID is not present from all of the data servers (step S908: NO), the data server 15b transmits a message of guiding redirection to another similar kinds of application, along with a message indicating failure in establishing a session, to the transmission source of the message (step S910), and ends the processing.

### Effects of Third Embodiment

As described above, the data server 15b calculates an interim identifier from a fixed identifier by using a hash function different per representative address assigned to the allocation server 12a. Moreover, the data server 15b accepts allocation of a message from the allocation server 12a that allocates a message by using a hash function different per representative address that is assigned to the allocation server 12a. Therefore, the data server 15b can expand a creatable interim identifier space, thereby preventing lack of interim identifiers.

Moreover, when all usable interim identifiers have been issued and an unused interim identifier is not available, the data server 15b determines whether an unused interim identifier including F(x) that is calculated by using another hash function is present. When determining that an unused interim identifier is present, the data server 15b informs a representative address in which allocation of a message is performed by using the other hash function, to the transmission source of the message.

That is, when a hash value of a fixed identifier is embedded in a part of an interim identifier, the number of allocatable interim identifiers decreases. However, the data server 15b adopts a hash function that is different per representative address, and when a usable interim identifier runs out in one hash space of one hash function, data server 15b determines whether there is an availability in a hash space of another hash function. When there is an availability in the hash space of the other hash function, informs a representative address in which allocation is performed by using the other hash function, to the transmission source of the message. Therefore, the data server 15b can prevent lack of interim identifiers.

Furthermore, the data server 15b inquires other data servers whether an unused interim identifier including F(x) that is calculated by using the other hash function. When it is determined that un used interim identifier is present in either one of the other data servers, the data server 15b informs a representative address in which allocation of a message is performed by using the other hash function, to the transmission source of the message. Therefore, the data server 15b can use interim identifiers without waste, and thereby prevent lack of interim identifiers.

### [d] Fourth Embodiment

Embodiments of the present invention have been explained. The embodiments may be implemented in various different forms other than the embodiments described above. Accordingly, another embodiment is explained as a fourth embodiment below.

Encryption of Hash Value

The data server 15 described above creates an interim identifier that includes a part of a calculated hash value. However, the disclosed technique is not limited thereto. For example, the data server 15 may create an interim identifier that includes an entire calculated hash value, or may encrypt a calculated hash value by a predetermined method to create an interim identifier that includes the encrypted hash value. When the processing as above is performed, it is possible to make processing of estimating a fixed identifier from a hash value difficult even when the interim identifier is stolen. As a result of this, the data server 15 can reduce a security risk.

Embedding Position of Hash Value

Moreover, the data server 15 may embed a part of a calculated hash value in an interim identifier, and embed a remaining value of the calculated hash value in another region of a message. For example, when a representative address is stored in a packet used at the time of transmitting and receiving the message, the data server 15 may embed the remaining value of the calculated hash value in lower bits of the representative address. Furthermore, the data server 15 may embed the remaining value of the calculated hash value in lower bits of a port number that is used in a transport layer.

If the processing as above is performed, when multiple representative addresses can be reserved as bands to allocate a message, of when a port number in the transport layer can be used without restraint, a part of a hash value can be embedded in a part of a representative address, a port number, or the like. As a result, the data server 15 can reduced the digits of the hash value to be embedded in an interim identifier, and therefore can increase the number of usable interim identifiers. Moreover, the data server 15 suppresses decrease in the number of users that can be accommodated even when a communication protocol that uses an interim identifier having short bit length is adopted, and therefore, a range of communication protocols to which the processing can be applied can be expanded.

Application to Other Devices

The configuration of the MME 8 described above is also applicable to a service node other than 3GPP, for example, to the eNB 6 and the S/P-GW 10. Moreover, the configuration of the MME 8 is also applicable to a home subscriber server (HSS), a policy and charging rules function (PCRF), a radio network controller (RNC), and the like. Furthermore, the configuration of the MME 8 is also applicable to a serving GPRS support node (SGSN), a gateway GPRS support node (GGSN), and the like.

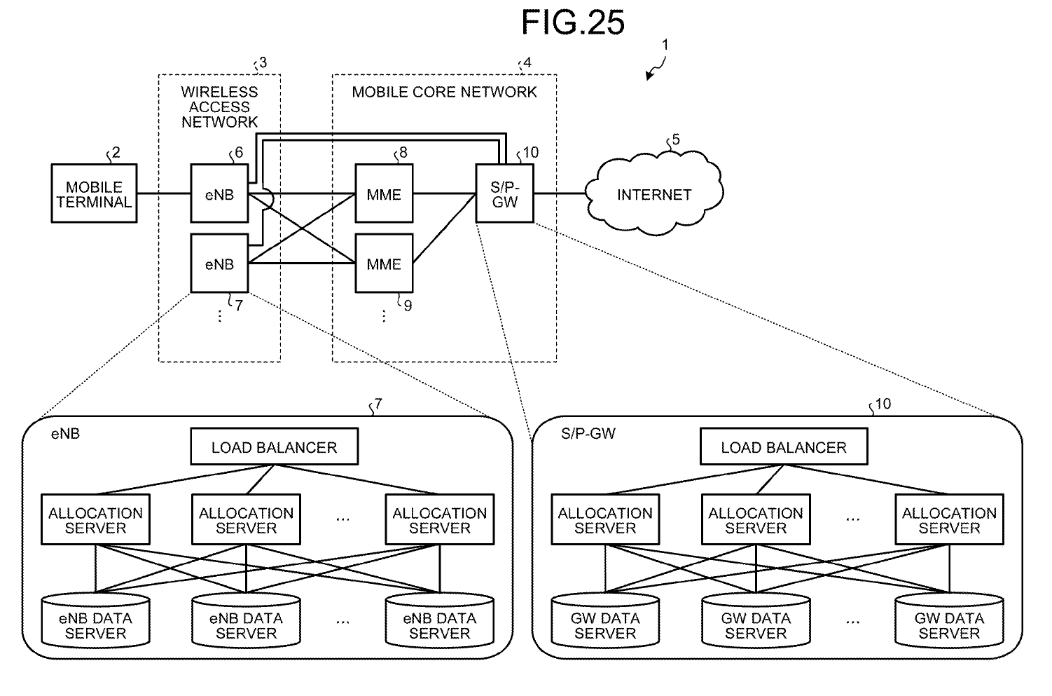

For example, FIG. 25 is a block diagram depicting one example of an internal configuration of the eNB and the S/P-GW. As depicted in FIG. 25, the eNB 7 is constituted of a load balancer, multiple allocation servers, and multiple eNB data servers similarly to the MME 8, and may exert a function as an eNB by performing management processing similarly to that of the MME 8. The S/P-GW 10 is constituted of a load balancer, multiple allocation servers, and multiple GW data servers similarly to the MME 8, and may exert a function as the S/P-GW by performing management processing similar to the MME 8.

Hardware

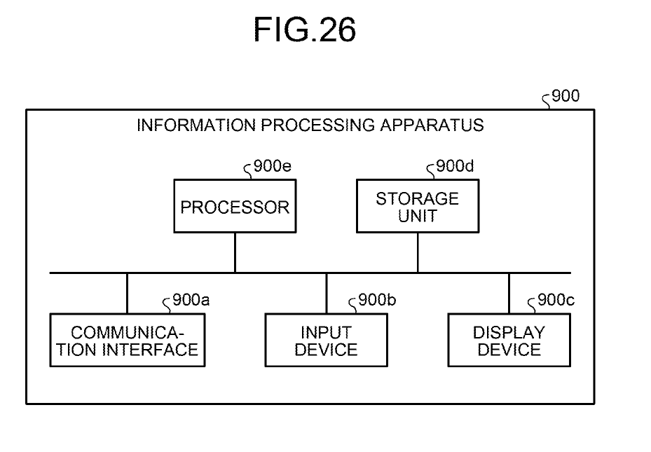

FIG. 26 is a block diagram depicting a hardware configuration example of the allocation server and the data server. The hardware configuration example described herein is a configuration example of the allocation server 12, the data server 15, and the like explained in FIG. 2, and explanation is given herein as an information processing apparatus 900.

As depicted in FIG. 26, the information processing apparatus 900 includes a communication interface 900a, an input device 900b, a display device 900c, a storage unit 900d, and a processor 900e. Note that the hardware configuration depicted in FIG. 26 is one example, and another hardware may be included.

The communication interface 900a is an interface that establishes a communication path with other devices and performs transmission and reception of data, and is, for example, a network interface card, a wireless interface, and the like.

The input device 900b is a device that accepts an input from a user and the like, and is for example, a mouse, a keyboard, and the like. The display device 900c is a display, a touch panel, and the like that display various kinds of information.

The storage unit 900d is a storage device that stores data and various kinds of programs to perform various functions of the allocation server 12 and the data server 15. For example, the storage unit 900d stores information similar to the storage unit 22 depicted in FIG. 3 or the storage unit 34 depicted in FIG. 9. As one example of the storage unit 900d, there are a read-only memory (ROM), a random access memory (RAM), a hard disk, and the like.

The processor 900e controls processing performed by the information processing apparatus 900, by using a program or data stored in the storage unit 900d. As one example of the processor 900e, there is a central processing unit (CPU), a micro processing unit (MPU), and the like. This processor 900e develops a program stored in a ROM or the like on a RAM, and performs various kinds of processes corresponding to the various kinds of processing. For example, the processor 900e operates processes to perform processing similar to that of the load-distribution processing unit 21 depicted in FIG. 3 and the embedding processing unit 38 depicted in FIG. 9.

Functional Configuration

Among the processing described above, all or a part of the processing explained as performed automatically can also be performed manually. Alternatively, all or a part of the processing explained as performed manually can be performed automatically by a known method. In addition, a processing procedure, specific names, and information including various kinds of data and parameters can be arbitrarily modified unless otherwise specified.

Furthermore, respective illustrated configuration components of the respective devices are of a functional concept, and are not necessarily requested to be physically configured as illustrated. That is, a specific mode of distribution or integration of the respective devices is not limited to the ones illustrated in the drawings. That is, all or a part thereof can be distributed or integrated functionally or physically in an arbitrary unit to be configured.

Moreover, as for the respective processing functions performed in the respective devices, all or a part thereof is implemented by a CPU and a program that is analyzed and executed by the CPU, or is implemented as hardware by wired logic.

In one aspect, the uniqueness of a server that processes packets included in the same session can be maintained in a cluster system.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a processor configured to execute a process including:
extracting, when an execution request of processing is received, a fixed identifier that is an identifier indicating a transmission source, and that has a fixed value, from the execution request;
calculating a hash value of the fixed identifier extracted at the extracting, by using a predetermined hash function;
creating a value that indicates the transmission source, and that includes the hash value calculated at the calculating in a part thereof, as an interim identifier that varies in value according to an execution condition of the processing; and
communicating with the transmission source by using the interim identifier created at the creating.

2. The communication device according to claim 1, wherein the calculating includes calculating the hash value of the fixed identifier, by using a hash function to calculate a hash value having an expression length according to number of communication devices to which the execution request of the processing is allocated.

3. The communication device according to claim 1, wherein the creating includes creating a value including a value that is obtained by encrypting the hash value calculated at the calculating in a part thereof, as the interim identifier.

4. The communication device according to claim 1, wherein the creating includes creating a value in which the hash value calculated at the calculating is embedded in a position according to a protocol that is used when communication is performed at the communicating, as the interim identifier.

5. The communication device according to claim 1, wherein the creating includes creating a value that is different per signaling session that includes a series of processing, as the interim identifier.

6. The communication device according to claim 1, wherein the process further includes performing a predetermined processing by using the interim identifier when the interim identifier created at the creating is included in the execution request.

7. The communication device according to claim 1, wherein
the creating includes creating, when an execution request of processing that is performed by using one or a plurality of external systems is received, a plurality of interim identifiers that include a hash value calculated at the calculating in a part thereof, and that have a different value for each of the external systems that perform the processing, and
the communicating includes communicating with each of the external systems by using the interim identifiers created at the creating for each of the external systems.

8. The communication device according to claim 1, wherein the creating includes calculating a hash value of the fixed identifier by using a hash function that is different per address of a transmission source of the execution request of the processing.

9. The communication device according to claim 8, wherein the process further includes receiving the execution request of the processing from an allocation device that allocates the execution request of the processing to a plurality of communication devices by using a hash function that is different per address of a transmission source of the execution request of the processing.

10. The communication device according to claim 9, wherein the creating includes determining, when an interim identifier that includes a hash value calculated from the fixed identifier by using a predetermined hash function is being used, whether an unused interim identifier is present among interim identifiers that include a hash value that is calculated from the fixed identifier by using a hash function different from the predetermined hash function, and informing, when determining that an unused interim identifier is present, the address in which the allocation is performed by using the hash function different from the predetermined hash function, to the transmission source.

11. The communication device according to claim 10, wherein the creating includes sending an inquiry to other communication devices to be an allocation destination of the execution request of the processing when an unused interim identifier is not present among interim identifier that include a hash value calculated from the fixed identifier by using a hash function different from the predetermined hash function, and informing, when the unused interim identifier is present in either of the other communication devices, the address in which the allocation is performed by using the hash function different from the predetermined hash function, to the transmission source.

12. The communication device according to claim 10, wherein the creating includes handling an interim identifier for which a predetermined period of time has passed since an end of previous use as the unused interim identifier.

13. The communication device according to claim 1, wherein the communicating includes embeding a part of the interim identifier in a part of any one of an address and a port number that is used when the execution request is transmitted to the communication device, out of information that is transmitted to the transmission source.

14. A managing method comprising:
extracting, when an execution request of processing is received, a fixed identifier that is an identifier indicating a transmission source, and that has a fixed value, from the execution request, by a processor;
calculating a hash value of the extracted fixed identifier, by using a predetermined hash function, by the processor;
creating a value that indicates the transmission source, and that includes the calculated hash value in a part thereof, as an interim identifier that varies in value according to an execution condition of the processing, by the processor; and
communicating with the transmission source by using the created interim identifier.
